(19) United States
(12) Patent Application Publication
(10) Pub. No.: US 2023/0314679 A1
(43) Pub. Date: Oct. 5, 2023

(54) LAMINATED OPTICAL FILM AND IMAGE DISPLAY DEVICE

(71) Applicant: FUJIFILM Corporation, Tokyo (JP)

(72) Inventors: Naoyoshi YAMADA, Minamiashigara-shi (JP); Yohei HAMACHI, Minamiashigara-shi (JP)

(73) Assignee: FUJIFILM Corporation, Tokyo (JP)

(21) Appl. No.: 18/297,377

(22) Filed: Apr. 7, 2023

Related U.S. Application Data
(63) Continuation of application No. PCT/JP2021/037478, filed on Oct. 8, 2021.

(30) Foreign Application Priority Data
Oct. 9, 2020 (JP) 2020-171318
Feb. 17, 2021 (JP) 2021-023627
Apr. 9, 2021 (JP) 2021-066717

(51) Int. Cl. G02B 5/20; G02B 1/11; G02B 5/30

(52) U.S. Cl. CPC G02B 5/3016; G02B 1/11; G02B 5/208; G02B 5/3083

(57) ABSTRACT

An object of the present invention is to provide a laminated optical film including a reflective circular polarizer with high image sharpness of a reflected image, and an image display device formed of the laminated optical film. The object is achieved by providing the laminated optical film including at least a reflective circular polarizer, a retardation layer that converts circularly polarized light into linearly polarized light, and a linear polarizer in this order, in which a surface of the reflective circular polarizer on a side opposite to the linear polarizer has a surface roughness Ra of 100 nm or less.

### CROSS-REFERENCE TO RELATED APPLICATIONS

This application is a Continuation of PCT International Application No. PCT/JP2021/037478 filed on Oct. 8, 2021, which claims priority under 35 U.S.C. § 119(a) to Japanese Patent Application No. 2020-171318 filed on Oct. 9, 2020, Japanese Patent Application No. 2021-023627 filed on Feb. 17, 2021, and Japanese Patent Application No. 2021-066717 filed on Apr. 9, 2021. The above applications are hereby expressly incorporated by reference, in their entirety, into the present application.

### BACKGROUND OF THE INVENTION

### 1. Field of the Invention

The present invention relates to a laminated optical film including a reflective circular polarizer, a retardation layer that converts circularly polarized light into linearly polarized light, and a linear polarizer in this order and having a surface roughness Ra of 100 nm or less, and an image display device formed of the laminated optical film.

### 2. Description of the Related Art

The reflective polarizer is a polarizer having a function of reflecting one polarized light in incidence rays and transmitting the other polarized light. The reflected light and the transmitted light due to the reflective polarizer are in a state of polarized light orthogonal to each other. Here, the state of polarized light orthogonal to each other denotes a state of polarized light both positioned at antipodal points on the Poincare sphere, and for example, linearly polarized light orthogonal to each other, and clockwise circularly polarized light and counterclockwise circularly polarized light are in the corresponding state.

As a reflective linear polarizer in which transmitted light and reflected light are converted into linearly polarized light, for example, a film obtained by stretching a dielectric multilayer film as described in JP2011-053705A and a wire grid polarizer as described in JP2015-028656A are known.

Further, as a reflective circular polarizer in which transmitted light and reflected light are converted into circularly polarized light, for example, a film having a layer obtained by immobilizing a cholesteric liquid crystalline phase as described in JP6277088B is known.

A reflective polarizer is used for the purpose of extracting only specific polarized light from incidence rays or separating incidence rays into two polarized light.

For example, in a liquid crystal display device, the reflective polarizer is used as a luminance-improving film that enhances light utilization efficiency by reflecting unnecessary polarized light from backlight and reusing the light. Further, in a liquid crystal projector, the reflective polarizer is also used as a beam splitter that separates light from a light source into two linearly polarized light and supplies each of the two linearly polarized light to a liquid crystal panel.

In addition, in recent years, a method of using a reflective polarizer has been suggested for the purpose of generating a virtual image and a real image by partially reflecting external light and light from an image display device.

For example, JP2017-227720A discloses an in-vehicle room mirror that reflects light from behind using a reflective polarizer. Further, JP1995-120679A (JP-H7-120679A) discloses a method of generating a virtual image by reflecting light between a reflective polarizer and a half mirror to reciprocate the light in order to reduce the size and the thickness of a display unit in a virtual reality display device, an electronic finder, or the like. Further, JP2018-092135A discloses a method of generating a real image in the air by using a reflective polarizer and a retroreflective plate.

### SUMMARY OF THE INVENTION

According to the examination conducted by the present inventors, it was found that in a case where a reflective polarizer partially reflects external light and light from an image display device to generate a virtual image and a real image, the sharpness of the image may be decreased in a case where any of the reflective polarizers of the related art described in JP2011-053705A, JP2015-028656A, and JP6277088B is used.

The present invention has been made in view of the above-described problems, and an object to be achieved by the present invention is to provide a laminated optical film including a reflective circular polarizer with high image sharpness of a reflected image, and an image display device formed of the laminated optical film.

As a result of intensive examination repeatedly conducted by the present inventors on the above-described object, it was found that the above-described object can be achieved by the following configurations.

[1] A laminated optical film comprising, in the following order, at least: a reflective circular polarizer; a retardation layer that converts circularly polarized light into linearly polarized light; and a linear polarizer, in which a surface of the reflective circular polarizer on a side opposite to the linear polarizer has a surface roughness Ra of 100 nm or less.

The laminated optical film according to [1], further comprising: a support having a surface roughness Ra of 50 nm or less.

The laminated optical film according to [2], in which the support is a resin base material having a tan δ peak temperature of 170° C. or lower.

The laminated optical film according to [1], in which the laminated optical film does not have a support.

The laminated optical film according to any one of [1] to [4], in which the reflective circular polarizer includes at least a light reflecting layer formed by immobilizing a cholesteric liquid crystalline phase.

The laminated optical film according to any one of [1] to [5], in which the reflective circular polarizer includes at least a blue light reflecting layer with a reflectivity of 40% or greater for light having a wavelength of 450 nm, a green light reflecting layer with a reflectivity of 40% or greater for light having a wavelength of 530 nm, and a red light reflecting layer with a reflectivity of 40% or greater for light having a wavelength of 630 nm.

The laminated optical film according to [6], in which the reflective circular polarizer further includes an infrared light reflecting layer with a reflectivity of 40% or greater for light having a wavelength of 800 nm.

The laminated optical film according to any one of [1] to [7], in which the reflective circular polarizer includes at least a light reflecting layer formed by immobilizing a cholesteric liquid crystalline phase containing a rod-like liquid crystal compound and a light reflecting layer formed by immobilizing a cholesteric liquid crystalline phase containing a disk-like liquid crystal compound.

The laminated optical film according to any one of [1] to [8], in which the retardation layer has substantially reverse dispersibility with respect to a wavelength.

The laminated optical film according to any one of [1] to [9], in which the retardation layer includes at least a layer formed by immobilizing a uniformly aligned liquid crystal compound.

The laminated optical film according to any one of [1] to [10], in which the retardation layer includes at least a layer formed by immobilizing a twistedly aligned liquid crystal compound with a helical axis in a thickness direction.

The laminated optical film according to any one of [1] to [11], in which the linear polarizer consists of a layer having a thickness of 10 µm or less.

The laminated optical film according to any one of [1] to [12], in which the linear polarizer includes at least a light absorption anisotropic layer containing a liquid crystal compound and a dichroic substance.

The laminated optical film according to any one of [1] to [13], further comprising: a positive C-plate.

The laminated optical film according to any one of [1] to [14], further comprising: an antireflection layer on any surface.

The laminated optical film according to [15], in which the antireflection layer is a moth-eye film or an AR film.

An image display device comprising: the laminated optical film according to any one of [1] to [16]; and an image display element.

The image display device according to [17], in which the image display device is a virtual reality display device.

According to the present invention, it is possible to provide a laminated optical film with high image sharpness of a reflected image, and an image display device formed of the laminated optical film.

### BRIEF DESCRIPTION OF THE DRAWINGS

FIG. 1 is an example of a virtual reality display device formed of a laminated optical film of the present invention.

FIG. 2 is an example of a virtual reality display device formed of the laminated optical film of the present invention.

FIG. 3 is a schematic view illustrating an example of the laminated optical film according to the present invention.

### DESCRIPTION OF THE PREFERRED EMBODIMENTS

Hereinafter, the present invention will be described in detail with reference to the accompanying drawings. The description of configuration requirements below may be made based on typical embodiments or specific examples, but the present invention is not limited to such embodiments. In addition, in the present specification, a numerical range shown using “to” indicates a range including numerical values described before and after “to” as a lower limit and an upper limit.

In the present specification, the term “orthogonal” does not denote that the angle formed by two axes or the like is exactly 90°, but denotes 90° ± 10° and preferably 90° ± 5°. In addition, the term “parallel” does not denote that the angle formed by two axes or the like is exactly 0°, but denotes 0° ± 10° and preferably 0° ± 5°. Further, the angle “45°” does not denote that the angle formed by two axes or the like is exactly 45°, but denotes 45° ± 10° and preferably 45° ± 5°.

Here, in the expression related to polarized light, “state of polarized light orthogonal to each other” denotes a state of polarized light both positioned at antipodal points on the Poincare sphere, and for example, linearly polarized light orthogonal to each other, and clockwise circularly polarized light (dextrorotatory circularly polarized light) and counterclockwise circularly polarized light (levorotatory circularly polarized light) are in the corresponding state as described above.

In the present specification, the term “absorption axis” denotes a polarization direction in which the absorbance is maximized in a plane in a case where linearly polarized light is incident. Further, the term “reflection axis” denotes a polarization direction in which the reflectivity is maximized in a plane in a case where linearly polarized light is incident. Further, the term “transmission axis” denotes a direction orthogonal to the absorption axis or the reflection axis in a plane. Further, the term “slow axis” denotes a direction in which the refractive index is maximized in a plane.

In the present specification, the retardation denotes in-plane retardation unless otherwise specified, and is referred to as Re (λ). Here, Re (λ) represents in-plane retardation at a wavelength λ, and the wavelength λ is 550 nm unless otherwise specified.

In addition, the retardation at the wavelength λ in the thickness direction is referred to as Rth (λ) in the present specification.

As Re (λ) and Rth (λ), values measured at the wavelength λ with AxoScan OPMF-1 (manufactured by Opto Science, Inc.) can be used. By inputting an average refractive index ((nx + ny + nz)/3) and a film thickness (d (µm)) to AxoScan, the slow axis direction (°), “Re (λ) = R0 (λ)”, and “Rth (λ) = ((nx + ny)/2 - nz) × d” are calculated.

### Laminated Optical Film

A laminated optical film according to the embodiment of the present invention includes at least a reflective circular polarizer, a retardation layer that converts circularly polarized light into linearly polarized light, and a linear polarizer in this order, in which a surface of the reflective circular polarizer on a side opposite to the linear polarizer has a surface roughness Ra of 100 nm or less. Further, the surface roughness Ra is an arithmetic average roughness Ra.

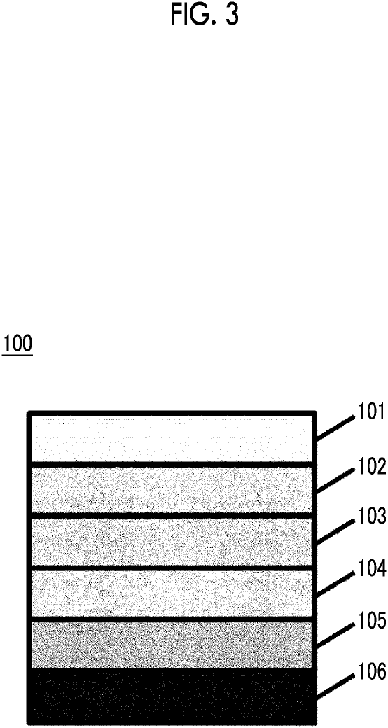

FIG. 3 conceptually illustrates an example of the laminated optical film according to the embodiment of the present invention.

A laminated optical film 100 illustrated in FIG. 3 includes an antireflection layer 101, a positive C-plate 102, a reflective circular polarizer 103, a positive C-plate 104, a retardation layer 105, and a linear polarizer 106 from the upper side in the figure. The retardation layer 105 is a retardation layer that converts circularly polarized light into linearly polarized light.

As described above, in the laminated optical film according to the embodiment of the present invention, the surface of the reflective circular polarizer on a side opposite to the linear polarizer has a surface roughness Ra of 100 nm or less. In other words, in the laminated optical film according to the embodiment of the present invention, the surface roughness Ra of the surface on a side opposite to the linear polarizer as viewed from the reflective circular polarizer is 100 nm or less.

Therefore, in the laminated optical film 100 illustrated in FIG. 3, the surface roughness Ra of the surface of the antireflection layer 101, that is, the uppermost surface in the figure is 100 nm or less.

In a case where the laminated optical film according to the embodiment of the present invention, including a reflective circular polarizer, a retardation layer that converts circularly polarized light into linearly polarized light, and a linear polarizer in this order has such a configuration, the sharpness (definition) of reflected light is high, and an image with high sharpness can be displayed in a case where the laminated optical film is used in, for example, an image display device.

That is, an image display device according to the embodiment of the present invention that is formed of the laminated optical film according to the embodiment of the present invention is an image display device capable of displaying an image with high sharpness.

Further, as will be described in examples below, the laminated optical film according to the embodiment of the present invention is not limited to the configuration illustrated in FIG. 3.

That is, configurations of various layers, such as a configuration having no antireflection layer and a configuration having only one layer of a positive C-plate, can be used as the configuration of the laminated optical film according to the embodiment of the present invention as long as the laminated optical film includes a reflective circular polarizer, a retardation layer, and a linear polarizer.

Further, the laminated optical film 100 illustrated in FIG. 3 does not include a support, but the present invention is not limited thereto.

That is, the laminated optical film according to the embodiment of the present invention may have a support that does not exhibit optical actions, to support the laminated optical film and/or each layer (film) constituting the laminated optical film.

In a step of forming each layer constituting the laminated optical film such as the antireflection layer 101 or the positive C-plate 102, a support that is provided to form and support these layers may remain in the laminated optical film according to the embodiment of the present invention. Alternatively, the support may be provided separately from each layer in order to support the laminated optical film.

Therefore, in the laminated optical film according to the embodiment of the present invention, the number of supports and the position of the supports are not limited, and various configurations can be used for the support. However, from the viewpoint of the surface roughness Ra described above, it is preferable that the number of supports is small. Therefore, as in the example illustrated in FIG. 3, a configuration having no support is preferably exemplified. The details thereof will be described below.

The laminated optical film according to the embodiment of the present invention is, for example, combined with an image display element to constitute the image display device according to the embodiment of the present invention.

As described above, the laminated optical film according to the embodiment of the present invention includes a reflective circular polarizer, a retardation layer, and a linear polarizer in this order. Further, as described below, in the image display device, the laminated optical film according to the embodiment of the present invention is disposed such that light transmitted through the reflective circular polarizer is incident on the retardation layer. Further, as described above, in the laminated optical film according to the embodiment of the present invention, the surface of the reflective circular polarizer on a side opposite to the linear polarizer has a surface roughness Ra of 100 nm or less.

Therefore, in the laminated optical film according to the embodiment of the present invention, the surface having a surface roughness Ra of 100 nm is disposed on a side of the image display element.

That is, in a case where the laminated optical film according to the embodiment of the present invention is used in the image display device, the surface having a surface roughness Ra of 100 nm is an incident surface of an image displayed by the image display element.

As described above, the laminated optical film according to the embodiment of the present invention can be used as a reflection transmission circular polarizer with high sharpness of transmitted light.

The actions of the laminated optical film according to the embodiment of the present invention will be described in detail by describing a virtual reality (VR) display device as a suitable use example of the image display device according to the embodiment of the present invention which is formed of the laminated optical film according to the embodiment of the present invention.

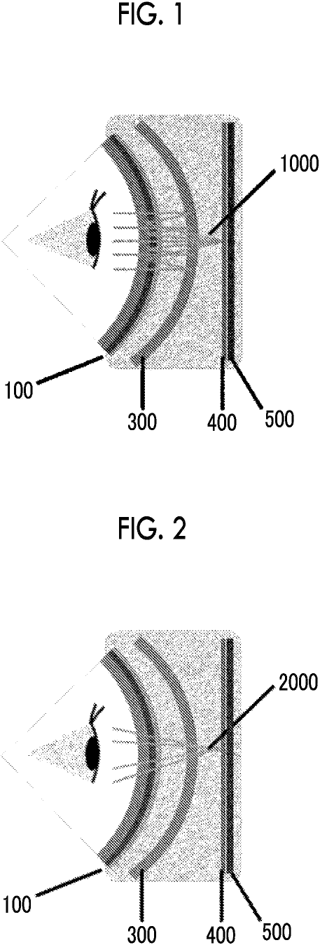

FIG. 1 illustrates a virtual reality display device formed of the laminated optical film 100 according to the embodiment of the present invention.

As described above, in a case where the virtual reality display device is used as the image display device, the laminated optical film 100 according to the embodiment of the present invention is disposed such that the surface having a surface roughness Ra of 100 nm or less faces the display element.

The virtual image display device illustrated in FIG. 1 includes an image display panel 500 which is an image display element, a circularly polarizing plate 400, a half mirror 300, and the laminated optical film 100 according to the embodiment of the present invention.

In the virtual image display device, a ray 1000 (displayed image) emitted by the image display panel 500 is transmitted through the circularly polarizing plate 400 to be converted into circularly polarized light and is transmitted through the half mirror 300 as illustrated in FIG. 1. The circularly polarizing plate 400 converts the ray 1000 into circularly polarized light in a revolution direction in which the reflective circular polarizer 103 of the laminated optical film 100 is reflected.

Next, the ray 1000 is incident on the laminated optical film 100 according to the embodiment of the present invention from the side of the antireflection layer 101 and is totally reflected by the reflective circular polarizer 103.

The ray 1000 totally reflected by the reflective circular polarizer 103 is reflected by the half mirror 300 again and is incident on the laminated optical film 100 again. Here, since the ray 1000 is reflected by the half mirror 300, the ray 1000 is converted into circularly polarized light orthogonal to circularly polarized light in a case of incidence on the laminated optical film 100 for the first time. Therefore, the ray 1000 is transmitted through the laminated optical film 100 and visually recognized by a user. Specifically, the ray 1000 is transmitted through the reflective circular polarizer 103 and converted into linearly polarized light by the retardation layer 105. The retardation layer 105 converts the ray 1000 (circularly polarized light) transmitted through the reflective circular polarizer 103 into linearly polarized light in a direction in which the light is transmitted through the linear polarizer 106. Therefore, the ray 1000 converted into linearly polarized light by the retardation layer 105 is transmitted through the linear polarizer 106 and visually recognized by the user.

Here, as described above, the surface of the antireflection layer 101 in the laminated optical film 100 has a surface roughness Ra of 100 nm or less. Therefore, the image visually recognized by the user is an image with less distortion and high sharpness. This point will be described in detail later.

Further, in a case where the ray 1000 is reflected by the half mirror 300, since the half mirror has a concave mirror shape, the image is magnified so that the user can visually recognize the magnified virtual image. The system described above is referred to as a reciprocating optical system, a folded optical system, or the like.

Meanwhile, FIG. 2 is a schematic view illustrating a case where the ray radiated by the image display panel 500 is turned into a ray 2000 that is leakage light, without being reflected in a case where the ray is incident on the laminated optical film for the first time. As can be seen from FIG. 2, the user visually recognizes an image which has different optical path lengths and is not magnified at this time. This image is referred to as a ghost, stray light, or the like, and the amount thereof is required to be reduced.

As a preferable aspect, the laminated optical film 100 of the illustrated example in the figure includes a positive C-plate 102 and a positive C-plate 104 for adjusting the Rth.

Therefore, the reflected light in the laminated optical film 100 has a high polarization degree. As a result, the reflectivity in a case where the ray is incident on the laminated optical film 100 for the first time can be increased, and thus leakage light and ghosts can be reduced.

Further, in a case where the laminated optical film 100 of the illustrated example in the figure has the above-described configuration as a preferable aspect, transmitted light also has a high polarization degree. Therefore, the transmittance in a case where the ray is incident on the laminated optical film 100 for the second time can be increased, the brightness of the virtual image can be improved, and the tinting of the virtual image can be suppressed.

As illustrated in FIGS. 1 and 2, the laminated optical film 100 may be molded into a curved surface shape according to the shape of a lens or the like constituting an image display device.

Since a laminated optical film obtained by laminating a reflective linear polarizer and a retardation layer having a retardation of a ¼ wavelength, which is known as a reflective circular polarizer in the related art, has optical axes such as a transmission axis, a reflection axis, and a slow axis, the optical axis is distorted in a case of being molded, stretched, or the like into a curved surface shape, and thus the polarization degrees of transmitted light and reflected light are decreased.

On the contrary, in the laminated optical film according to the embodiment of the present invention, for example, since the reflective circular polarizer is formed of a light reflecting layer obtained by immobilizing a cholesteric liquid crystalline phase, the reflective circular polarizer does not have an optical axis, and thus a decrease in the polarization degree due to stretching, molding, or the like is unlikely to occur. Therefore, even in a case where the laminated optical film 100 is formed into a curved surface shape, a decrease in the polarization degree is unlikely to occur.

Further, since the laminated optical film according to the embodiment of the present invention includes the reflective circular polarizer 103, the retardation layer 105 that converts circularly polarized light into linearly polarized light, and the linear polarizer 106 in this order, leakage light from the reflective circular polarizer 103 is converted into the linearly polarized light, and the light can be absorbed by the linear polarizer 106.

Specifically, as described above, the circularly polarizing plate 400 converts the ray 1000 into circularly polarized light reflected by the reflective circular polarizer 103 of the laminated optical film 100 in the revolution direction. Further, the retardation layer 105 converts circularly polarized light orthogonal to circularly polarized light selectively reflected by the reflective circular polarizer 103 into linearly polarized light in a direction of transmission through the linear polarizer 106.

Therefore, in a case where the circularly polarized light converted by the circularly polarizing plate 400 is transmitted through the reflective circular polarizer 103 and turned into leakage light (ray 2000), the circularly polarized light is converted into linearly polarized light by the retardation layer 105 in a direction orthogonal to the linearly polarized light transmitted through the linear polarizer 106. As a result, the leakage light transmitted through the reflective circular polarizer 103 is absorbed by the linear polarizer 106.

Therefore, according to the laminated optical film 100 according to the embodiment of the present invention, the polarization degree of transmitted light can be increased by preventing unnecessary transmission of light.

Further, in a case where the laminated optical film is stretched or molded, the slow axis of the retardation layer 105 and the absorption axis of the linear polarizer 106 may be distorted. However, as described above, the amount of leakage light from the reflective circular polarizer is small because the reflected light and the transmitted light still have a high polarization degree even in a case where the reflective circular polarizer 103 is stretched, molded, or the like, and thus an increase in the amount of leakage light is suppressed to be small.

Further, the laminated optical film according to the embodiment of the present invention includes at least a reflective circular polarizer, a retardation layer that converts circularly polarized light into linearly polarized light, and a linear polarizer in this order, in which the surface of the reflective circular polarizer on a side opposite to the linear polarizer has a surface roughness Ra of 100 nm or less. In a case of the laminated optical film 100 illustrated in FIG. 3, the surface roughness Ra of the antireflection layer 101 is 100 nm or less.

As described above, in a case where the laminated optical film according to the embodiment of the present invention is used in an image display device, the laminated optical film is disposed such that the incident surface of an image displayed by an image display element is the surface having a surface roughness Ra of 100 nm or less. In the description below, the expression “surface of the reflective circular polarizer on a side opposite to the linear polarizer” will also be referred to as “image incident surface” for convenience. Further, the expression “retardation layer that converts circularly polarized light to linearly polarized light” will also be simply referred to as “retardation layer”, and in the description of other retardation layers, notes, for example, “retardation layer that converts linearly polarized light into linearly polarized light orthogonal to the linearly polarized light” are added.

In the laminated optical film according to the embodiment of the present invention, the sharpness of the image can be improved by setting the surface roughness Ra of the image incident surface to 100 nm or less, for example, in a case where the laminated optical film is used in a virtual reality display device or the like.

The present inventors assumed that in a case where each layer constituting the laminated optical film has unevenness in a case of reflection of light by the laminated optical film including a reflective circular polarizer, the angle of the reflected light is distorted, the image is distorted, blurred, or the like, and thus the sharpness of the image is decreased.

Therefore, in the laminated optical film according to the embodiment of the present invention, it is preferable that all the layers have a small surface roughness Ra. Each layer constituting the laminated optical film according to the embodiment of the present invention has a surface roughness Ra of preferably 50 nm or less, more preferably 30 nm or less, and still more preferably 10 nm or less. In addition, from the viewpoint of increasing the image sharpness of the reflected image, it is particularly preferable that the reflective circular polarizer has a small surface roughness Ra.

Here, the laminated optical film according to the embodiment of the present invention is prepared by laminating a plurality of layers. According to the examination conducted by the present inventors, it has been found that in a case where a layer is laminated on a layer with unevenness, the unevenness may be superimposed and amplified.

Therefore, it is considered that the unevenness on the surface of the laminated optical film is formed by superimposing the unevenness of each layer constituting the laminated optical film. That is, it is considered that the surface roughness Ra of the image incident surface in the laminated optical film indicates all the degrees of unevenness of each layer constituting the laminated optical film.

That is, in the laminated optical film according to the embodiment of the present invention, the unevenness that causes distortion and blur of an image in each layer constituting the laminated optical film and results in a decrease of the sharpness of the image can be sufficiently reduced by setting the surface roughness Ra of the image incident surface to 100 nm or less.

Therefore, in a case where the laminated optical film according to the embodiment of the present invention is used in, for example, an image display device such as the virtual reality display device as described above, an image with high sharpness can be displayed.

In the laminated optical film according to the embodiment of the present invention, the surface roughness Ra of the image incident surface is 100 nm or less. In a case where the surface roughness Ra of the image incident surface is greater than 100 nm, an image with sufficiently high sharpness cannot be obtained in a case where the laminated optical film is used in an image display device or the like.

In the laminated optical film according to the embodiment of the present invention, the surface roughness Ra of the image incident surface is preferably 50 nm or less, more preferably 30 nm or less, and still more preferably 10 nm or less.

The surface roughness Ra of the image incident surface is basically preferably as small as possible, but is typically 5 nm or greater. In a case where the laminated optical films according to the embodiment of the present invention are stored or transported in a state of being overlapped with each other, adhesion between the films can be further prevented by setting the surface roughness Ra of the image incident surface to 5 nm or greater.

Further, the surface roughness Ra (arithmetic average roughness Ra) can be measured by, for example, a non-contact surface/layer cross-sectional shape measuring system VertScan (manufactured by Ryoka System, Inc.).

It is preferable that the number of point defects per unit area in the laminated optical film according to the embodiment of the present invention is small. That is, from the viewpoint that the point defects lead to a decrease in the polarization degree of transmitted light or reflected light and a decrease in the image sharpness, it is preferable that the number of point defects is small.

The laminated optical film according to the embodiment of the present invention is prepared by laminating a plurality of layers. Therefore, it is preferable that the number of point defects in each layer is also small in order to reduce the number of point defects in the entire laminated optical film. Specifically, the number of point defects in each layer is preferably 20 or less, more preferably 10 or less, and still more preferably 1 or less per square meter. The number of point defects in the entire laminated optical film is preferably 100 or less, more preferably 50 or less, and still more preferably 5 or less per square meter.

Here, the point defects include foreign matter, scratches, stains, fluctuations in film thickness, and alignment failure of a liquid crystal compound.

Further, in a case where the number of point defects with a size of preferably 100 µm or greater, more preferably 30 µm or greater, and still more preferably 10 µm or greater is counted, it is preferable that the number of point defects is as described above.

Further, in the laminated optical film according to the embodiment of the present invention, various sensors in which near-infrared light for eye tracking, facial expression recognition, iris recognition, and the like is used as a light source may be incorporated in optical systems such as a virtual reality display device, an electronic viewfinder, and the like. From this viewpoint, it is preferable that the laminated optical film according to the embodiment of the present invention is transparent to near-infrared light in order to minimize the influence on the sensors.

Hereinafter, each layer constituting the laminated optical film according to the embodiment of the present invention will be described.

### Reflective Circular Polarizer

The reflective circular polarizer used in the laminated optical film according to the embodiment of the present invention is an optical member that separates an incidence ray into clockwise circularly polarized light (dextrorotatory circularly polarized light) and counterclockwise circularly polarized light (levorotatory circularly polarized light), specularly reflects one circularly polarized light, and transmits the other circularly polarized light.

In a case where the laminated optical film is stretched or molded into a three-dimensional shape or the like, it is preferable that a film that functions as a reflective circular polarizer by itself is preferable as the reflective circular polarizer from the viewpoint of suppressing a decrease in the polarization degree and distortion of the polarization axis. Since a film that functions as a reflective circular polarizer by itself does not have a reflection axis and a transmission axis, there is little concern that the polarization axis is distorted even in a case where the laminated optical film is stretched, molded, or the like. Further, a decrease in the polarization degree due to distortion of the polarization axis is unlikely to occur.

As a film that functions as a reflective circular polarizer by itself, for example, an optical film having a light reflecting layer formed by immobilizing a cholesteric liquid crystalline phase can be used with reference to JP2020-060627A. An optical film having a light reflecting layer formed by immobilizing a cholesteric liquid crystalline phase is preferable from the viewpoint that both reflected light and transmitted light have a high polarization degree.

In the description below, the expression “layer formed by immobilizing the cholesteric liquid crystalline phase” will also be referred to as “cholesteric liquid crystal layer” for convenience.

It is preferable that the reflective circular polarizer used in the laminated optical film according to the embodiment of the present invention includes at least a blue light reflecting layer with a reflectivity of 40% or greater for light having a wavelength of 450 nm, a green light reflecting layer with a reflectivity of 40% or greater for light having a wavelength of 530 nm, and a red light reflecting layer with a reflectivity of 40% or greater for light having a wavelength of 630 nm. Such a configuration is preferable from the viewpoint that high reflection characteristics can be exhibited over a wide wavelength range in a visible region. Further, the above-described reflectivity is the reflectivity in a case where non-polarized light is incident on the reflective circular polarizer at each wavelength.

Some image display devices have emission peaks in the respective wavelength ranges of blue light, green light, and red light. For example, a liquid crystal display device having a backlight including quantum dots, a liquid crystal display device having a backlight provided with LEDs that emit blue light, green light, and red light, an organic EL display device, a micro LED display device, and the like have emission peaks with a full width at half maximum in the respective wavelength ranges of blue light, green light, and red light. It is preferable that the full width at half maximum of the emission peak of each color is narrow from the viewpoint of improving the color reproducibility. In a case where the reflective circular polarizer is used in combination with any of these image display devices, it is preferable that the reflective circular polarizer selectively has a reflection band in a wavelength range corresponding to the emission peak of the image display device.

In addition, the blue light reflecting layer, the green light reflecting layer, and the red light reflecting layer which are formed by immobilizing the cholesteric liquid crystalline phase may have a pitch gradient layer in which the helical pitch of the cholesteric liquid crystalline phase is continuously changed in the thickness direction. For example, the green light reflecting layer and the red light reflecting layer can be continuously prepared with reference to JP2020-060627A and the like.

Further, in a case where the laminated optical film according to the embodiment of the present invention is stretched or molded, since the reflection wavelength range of the reflective circular polarizer may be shifted to a short wavelength side, it is preferable that the reflection wavelength range is selected in consideration of the shift of the wavelength in advance.

For example, in a case where an optical film having a layer (cholesteric liquid crystal layer) formed by immobilizing a cholesteric liquid crystalline phase is used as the reflective circular polarizer, the film is stretched by being stretched, molded, or the like and thus the helical pitch of the cholesteric liquid crystalline phase may be reduced. Therefore, it is preferable that the helical pitch of the cholesteric liquid crystalline phase is set to be large in advance. Further, it is also preferable that the reflective circular polarizer includes an infrared light reflecting layer having a reflectivity of 40% or greater at a wavelength of 800 nm in consideration of the shift of the reflection wavelength range to the short wavelength side due to the stretching, molding, or the like.

Further, in a case where the stretching ratio in the stretching, molding, or the like is not uniform in the plane, an appropriate reflection wavelength range may be selected in each place in the plane according to the wavelength shift due to the stretching. That is, regions with different reflection wavelength ranges may be present in the plane. Further, it is also preferable that the reflection wavelength range is set wider than the required wavelength range in advance in consideration that the stretching ratios at the respective places in the plane are different from each other.

In the reflective circular polarizer used in the laminated optical film according to the embodiment of the present invention, it is preferable that the blue light reflecting layer, the green light reflecting layer, and the red light reflecting layer are laminated in this order. In addition, it is preferable that the blue light reflecting layer is disposed on a surface opposite to the retardation layer that converts circularly polarized light into linearly polarized light.

With such disposition, the ray passes through the blue light reflecting layer, the green light reflecting layer, and the red light reflecting layer in this order. The present inventors assumed that the polarization degree of the reflected light and the polarization degree of the transmitted light can be increased because the polarization degrees are unlikely to be affected by the Rth of each layer particularly in a case of oblique incidence with such disposition.

Further, it is also preferable that the reflective circular polarizer used in the laminated optical film according to the embodiment of the present invention includes a light reflecting layer formed by immobilizing a cholesteric liquid crystalline phase containing a rod-like liquid crystal compound and a light reflecting layer formed by immobilizing a cholesteric liquid crystalline phase containing a disk-like liquid crystal compound.

The above-described configuration is preferable because the cholesteric liquid crystalline phase containing the disk-like liquid crystal compound has a negative Rth while the cholesteric liquid crystalline phase containing the rod-like liquid crystal compound has a positive Rth, the Rths thereof are offset, and the polarization degrees of reflected light and transmitted light can be increased with respect to the incidence ray in the oblique direction.

According to the examination conducted by the present inventors, in this case, it is preferable that the reflective circular polarizer includes a blue light reflecting layer consisting of a cholesteric liquid crystalline phase containing a disk-like liquid crystal compound, a red light reflecting layer consisting of a cholesteric liquid crystalline phase containing a rod-like liquid crystal compound, and a green light reflecting layer consisting of a cholesteric liquid crystalline phase containing a rod-like liquid crystal compound in this order and that the blue light reflecting layer is disposed on a surface opposite to the retardation layer converting circularly polarized light into linearly polarized light.

Further, in a case where the reflective circular polarizer includes light reflecting layers consisting of a rod-like liquid crystal compound and a disk-like liquid crystal compound, it is preferable that the light reflecting layers are provided in order of a green light reflecting layer, a red light reflecting layer, and a blue light reflecting layer from the side of the image display element from the viewpoint of visual sensitivity.

Further, in a case where the reflective circular polarizer includes a light reflecting layer formed by immobilizing a cholesteric liquid crystalline phase containing a rod-like liquid crystal compound and a light reflecting layer formed by immobilizing a cholesteric liquid crystalline phase containing a disk-like liquid crystal compound, it is preferable that the kinds of the liquid crystals to be disposed are a disk-like liquid crystal, a rod-like liquid crystal, and a disk-like liquid crystal, or a disk-like liquid crystal, a rod-like liquid crystal, and a rod-like liquid crystal from the side of the image display element from the viewpoint of compensation.

Here, the order of the light reflecting layers and the kinds of the liquid crystals are merely examples, and the reflective circular polarizer of the laminated optical film according to the embodiment of the present invention is not limited to these configurations.

The thickness of the reflective circular polarizer is not particularly limited, but is preferably 20 µm or less and more preferably 10 µm or less from the viewpoint of reducing the thickness.

In the laminated optical film according to the embodiment of the present invention, the reflective circular polarizer may include a support, an alignment layer, and a light reflecting layer. In this case, the support and the alignment layer may be temporary supports that are peeled off and removed during the preparation of the laminated optical film. It is preferable that the reflective circular polarizer includes a temporary support from the viewpoint that the thickness of the laminated optical film can be reduced by transferring the reflective circular polarizer to another laminate and peeling and removing the temporary support and the adverse effect of the retardation of the temporary support on the polarization degrees of transmitted light and reflected light can be eliminated.

The kind of the support is not particularly limited, but it is preferable that the support is transparent, and examples of such a support include films made of cellulose acylate, polycarbonate, polysulfone, polyethersulfone, polyacrylate and polymethacrylate, cyclic polyolefin, polyolefin, polyamide, polystyrene, and polyester. Among these, a cellulose acylate film, cyclic polyolefin, polyacrylate, polymethacrylate, and the like are preferable. In addition, commercially available cellulose acetate films (for example, “TD80U” and “Z-TAC”, manufactured by FUJIFILM Corporation) and the like can also be used as the support.

In a case where the support is a temporary support, a support having high tear strength is preferable from the viewpoint of preventing breakage during peeling. For example, a polycarbonate-based film, a polyester-based film, and the like are preferable.

In addition, from the viewpoint of suppressing the adverse effect on the polarization degrees of transmitted light and reflected light, it is preferable that the support has a small retardation. Specifically, the magnitude of the in-plane retardation Re is preferably 10 nm or less, and the absolute value of the magnitude of the retardation Rth in the thickness direction is preferably 50 nm or less. Further, even in a case where the support is used as the temporary support described above, it is preferable that the temporary support has a small retardation from the viewpoint of performing quality inspection of the reflective circular polarizer and other laminates in the step of producing a laminated optical film.

In addition, it is preferable that the reflective circular polarizer used in the laminated optical film according to the embodiment of the present invention is transparent to near-infrared light in order to minimize the influence on various sensors incorporated in optical systems such as a virtual reality display device, an electronic viewfinder, and the like, in which near-infrared light for eye tracking, facial expression recognition, and iris recognition is used as a light source.

### Retardation Layer

The retardation layer used in the laminated optical film according to the embodiment of the present invention has a function of converting emitted light into linearly polarized light in a case where circularly polarized light is incident. For example, a retardation layer in which the Re is an approximately ¼ wavelength at any of the wavelengths in the visible region can be used as the retardation layer. Here, the in-plane retardation Re (550) at a wavelength of 550 nm in the retardation layer is preferably in a range of 120 to 150 nm, more preferably in a range of 125 to 145 nm, and still more preferably in a range of 135 to 140 nm.

Further, a retardation layer in which the in-plane retardation Re is an approximately ¾ wavelength and an approximately 5/4 wavelength is also preferable from the viewpoint that linearly polarized light can be converted into circularly polarized light.

Further, it is preferable that the retardation layer used in the laminated optical film according to the embodiment of the present invention has reverse dispersibility with respect to the wavelength. It is preferable that the retardation layer has reverse dispersibility from the viewpoint that circularly polarized light can be converted into linearly polarized light over a wide wavelength range in the visible region. Here, the expression “having reverse dispersibility with respect to the wavelength” denotes that as the wavelength increases, the value of the retardation at the wavelength increases.

The retardation layer having reverse dispersibility can be prepared, for example, by uniaxially stretching a polymer film such as a modified polycarbonate resin film having reverse dispersibility with reference to JP2017-049574A and the like.

In addition, the retardation layer having reverse dispersibility is not limited as long as the retardation layer substantially has reverse dispersibility, and can be prepared by laminating a retardation layer having an in-plane retardation Re of an approximately ¼ wavelength and a retardation layer having an in-plane retardation Re of an approximately ½ wavelength such that the slow axes form an angle of approximately 60° as disclosed in, for example, JP06259925B. Here, it is known that even in a case where the ¼ wavelength retardation layer and the ½ wavelength retardation layer each have forward dispersibility (as the wavelength increases, the value of the retardation at the wavelength decreases), circularly polarized light can be converted into linearly polarized light over a wide wavelength range in the visible region, and the layers can be regarded as having substantially reverse dispersibility. In this case, it is preferable that the laminated optical film according to the embodiment of the present invention includes a reflective circular polarizer, a ¼ wavelength retardation layer, a ½ wavelength retardation layer, and a linear polarizer in this order.

In addition, it is also preferable that the retardation layer used in the laminated optical film according to the embodiment of the present invention has a layer formed by immobilizing uniformly aligned liquid crystal compounds.

For example, a layer formed by uniformly aligning rod-like liquid crystal compounds horizontally to the in-plane direction, a layer formed by uniformly aligning disk-like liquid crystal compounds vertically to the in-plane direction, and the like can be used. Further, for example, a retardation layer having reverse dispersibility can be prepared by uniformly aligning rod-like liquid crystal compounds having reverse dispersibility and immobilizing the compounds with reference to JP2020-084070A and the like.

In addition, it is also preferable that the retardation layer used in the laminated optical film according to the embodiment of the present invention has a layer formed by immobilizing twistedly aligned liquid crystal compounds with a helical axis in the thickness direction.

For example, as disclosed in JP05753922B and JP05960743B, it is preferable that a retardation layer having a layer formed by immobilizing twistedly aligned rod-like liquid crystal compounds or twistedly aligned disk-like liquid crystal compounds with a helical axis in the thickness direction is used from the viewpoint that the retardation layer can be regarded as having substantially reverse dispersibility.

The thickness of the retardation layer is not particularly limited, but is preferably in a range of 0.1 to 8 µm and more preferably in a range of 0.3 to 5 µm from the viewpoint of reducing the thickness.

In the laminated optical film according to the embodiment of the present invention, the retardation layer may include a support, an alignment layer, a retardation layer, and the like. In this case, the support and the alignment layer may be temporary supports that are peeled off and removed during the preparation of the laminated optical film. It is preferable that a temporary support is used from the viewpoint that the thickness of the laminated optical film can be reduced by transferring the retardation layer to another laminate and peeling and removing the temporary support and the adverse effect of the retardation of the temporary support on the polarization degrees of transmitted light and reflected light can be eliminated.

The kind of the support is not particularly limited, but it is preferable that the support is transparent, and examples of such a support include films made of cellulose acylate, polycarbonate, polysulfone, polyethersulfone, polyacrylate and polymethacrylate, cyclic polyolefin, polyolefin, polyamide, polystyrene, and polyester. Among these, a cellulose acylate film, cyclic polyolefin, polyacrylate, polymethacrylate, and the like are preferable. In addition, commercially available cellulose acetate films (for example, “TD80U” and “Z-TAC”, manufactured by FUJIFILM Corporation) and the like can also be used as the support.

In a case where the support is a temporary support, a support having high tear strength is preferable from the viewpoint of preventing breakage during peeling. For example, a polycarbonate-based film, a polyester-based film, and the like are preferable.

In addition, from the viewpoint of suppressing the adverse effect on the polarization degrees of transmitted light and reflected light, it is preferable that the support has a small retardation. Specifically, the magnitude of the in-plane retardation Re is preferably 10 nm or less, and the absolute value of the magnitude of the retardation Rth in the thickness direction is preferably 50 nm or less. Further, even in a case where the support is used as the temporary support described above, it is preferable that the temporary support has a small retardation from the viewpoint of performing quality inspection of the retardation layer and other laminates in the step of producing a laminated optical film.

In addition, it is preferable that the retardation layer used in the laminated optical film according to the embodiment of the present invention is transparent to near-infrared light in order to minimize the influence on various sensors incorporated in optical systems such as a virtual reality display device, an electronic viewfinder, and the like, in which near-infrared light for eye tracking, facial expression recognition, and iris recognition is used as a light source.

### Linear Polarizer

The linear polarizer used in the laminated optical film according to the embodiment of the present invention is an absorption type polarizer, which absorbs linearly polarized light in the absorption axis direction among incidence rays and transmits linearly polarized light in the transmission axis direction.

A typical polarizer can be used as the linear polarizer, and preferred examples thereof include a polarizer in which a dichroic substance is dyed on polyvinyl alcohol or another polymer resin and is stretched so that the dichroic substance is aligned and a polarizer in which a dichroic substance is aligned by using alignment of a liquid crystal compound. Among these, from the viewpoints of the availability and an increase in the polarization degree, a polarizer obtained by dyeing polyvinyl alcohol with iodine and stretching polyvinyl alcohol is preferable.

The thickness of the linear polarizer is preferably 10 µm or less, more preferably 7 µm or less, and still more preferably 5 µm or less. In a case where the linear polarizer is thin, cracks, breakage, and the like can be prevented in a case where the laminated optical film is stretched or molded.

In addition, the single plate transmittance of the linear polarizer is preferably 40% or greater and more preferably 42% or greater. Further, the polarization degree of the linear polarizer is preferably 90% or greater, more preferably 95% or greater, and still more preferably 99% or greater. Further, in the present invention, the single plate transmittance and the polarization degree of the linear polarizer are measured using an automatic polarizing film measuring device: VAP-7070 (manufactured by Jasco Corporation).

Further, it is preferable that the direction of the transmission axis of the linear polarizer coincides with the direction of the polarization axis of light converted into linearly polarized light by the retardation layer. For example, in a case where the retardation layer is a layer having a retardation of a ¼ wavelength, the angle between the transmission axis of the linear polarizer and the slow axis of the retardation layer is preferably approximately 45°.

It is also preferable that the linear polarizer used in the laminated optical film according to the embodiment of the present invention is a light absorption anisotropic layer containing a liquid crystal compound and a dichroic substance. A linear polarizer containing a liquid crystal compound and a dichroic substance is preferable from the viewpoint that the thickness thereof can be reduced and cracks, breakage, and the like are unlikely to occur even in a case where the laminated optical film is stretched, molded, or the like.

The thickness of the light absorption anisotropic layer is not particularly limited, but is preferably in a range of 0.1 to 8 µm and more preferably in a range of 0.3 to 5 µm from the viewpoint of reducing the thickness.

The linear polarizer containing a liquid crystal compound and a dichroic substance can be prepared with reference to, for example, JP2020-023153A. From the viewpoint of improving the polarization degree of the linear polarizer, the alignment degree of the dichroic substance in the light absorption anisotropic layer is preferably 0.95 or greater and more preferably 0.97 or greater.

In a case where the linear polarizer used in the laminated optical film according to the embodiment of the present invention consists of a light absorption anisotropic layer containing a liquid crystal compound and a dichroic substance, the linear polarizer may include a support, an alignment layer, and a light absorption anisotropic layer. In this case, the support and the alignment layer may be temporary supports that are peeled off and removed during the preparation of the laminated optical film. It is preferable that a temporary support is used from the viewpoint that the thickness of the laminated optical film can be reduced by transferring the light absorption anisotropic layer to another laminate and peeling and removing the temporary support and the adverse effect of the retardation of the temporary support on the polarization degrees of transmitted light and reflected light can be eliminated.

The kind of the support is not particularly limited, but it is preferable that the support is transparent, and examples of such a support include films made of cellulose acylate, polycarbonate, polysulfone, polyethersulfone, polyacrylate and polymethacrylate, cyclic polyolefin, polyolefin, polyamide, polystyrene, and polyester. Among these, a cellulose acylate film, cyclic polyolefin, polyacrylate, polymethacrylate, and the like are preferable. In addition, commercially available cellulose acetate films (for example, “TD80U” and “Z-TAC”, manufactured by FUJIFILM Corporation) and the like can also be used as the support.

In a case where the support is a temporary support, a support having high tear strength is preferable from the viewpoint of preventing breakage during peeling. For example, a polycarbonate-based film, a polyester-based film, and the like are preferable.

In addition, from the viewpoint of suppressing the adverse effect on the polarization degrees of transmitted light and reflected light, it is preferable that the support has a small retardation. Specifically, the magnitude of the in-plane retardation Re is preferably 10 nm or less, and the absolute value of the magnitude of the retardation Rth in the thickness direction is preferably 50 nm or less. Further, even in a case where the support is used as the temporary support described above, it is preferable that the temporary support has a small retardation from the viewpoint of performing quality inspection of the light absorption anisotropic layer and other laminates in the step of producing a laminated optical film.

In addition, it is preferable that the linear polarizer used in the laminated optical film according to the embodiment of the present invention is transparent to near-infrared light in order to minimize the influence on various sensors incorporated in optical systems such as a virtual reality display device, an electronic viewfinder, and the like, in which near-infrared light for eye tracking, facial expression recognition, and iris recognition is used as a light source.

### Light Absorption Anisotropic Layer

Here, the light absorption anisotropic layer will be described in more detail. The light absorption anisotropic layer contains a liquid crystal compound and a dichroic substance, and the dichroic substance can be aligned in one direction by uniformly aligning the liquid crystal compound.

From the viewpoint of suppressing a decrease in the polarization degree in a case where the laminated optical film is stretched, molded, or the like, it is preferable that the liquid crystal compound and the dichroic substance contain a radically polymerizable group. In a case where the liquid crystal compound and the dichroic substance contain a radically polymerizable group, the molar content of the radically polymerizable group is preferably 0.6 mmol/g or greater, more preferably 1.0 mmol/g or greater, and still more preferably 1.5 mmol/g or greater with respect to the weight of the solid content of the composition used to form the light absorption anisotropic layer.

### <Liquid Crystal Compound>

A liquid crystal compound that does not exhibit dichroic properties in the visible region is preferable as a liquid crystal compound contained in the composition used to form the light absorption anisotropic layer.

As such a liquid crystal compound, both a low-molecular-weight liquid crystal compound and a polymer liquid crystal compound can be used. Here, “low-molecular-weight liquid crystal compound” denotes a liquid crystal compound having no repeating units in the chemical structure. Further, “polymer liquid crystal compound” denotes a liquid crystal compound having a repeating unit in the chemical structure.

Examples of the low-molecular-weight liquid crystal compound include liquid crystal compounds described in paragraphs [0027] to [0034] of JP2013-228706A. Among these, a low-molecular-weight liquid crystal compound exhibiting smectic properties is preferable.

Examples of the polymer liquid crystal compound include thermotropic liquid crystal polymers described in JP2011-237513A. Further, it is preferable that the polymer liquid crystal compound contains a crosslinkable group (such as an acryloyl group or a methacryloyl group) at a terminal.

The liquid crystal compound may be used alone or in combination of two or more kinds thereof. It is also preferable that the polymer liquid crystal compound and the low-molecular-weight liquid crystal compound are used in combination.

The content of the liquid crystal compound is preferably in a range of 25 to 2,000 parts by mass, more preferably in a range of 33 to 1,000 parts by mass, and still more preferably in a range of 50 to 500 parts by mass with respect to 100 parts by mass of the content of the dichroic substance in the present composition. In a case where the content of the liquid crystal compound is in the above-described ranges, the alignment degree of the polarizer is further improved.

From the viewpoint of further increasing the alignment degree of the light absorption anisotropic layer to be obtained, it is preferable that the liquid crystal compound is a polymer liquid crystal compound and more preferable that the liquid crystal compound is a polymer liquid crystal compound having a repeating unit represented by Formula (1) (hereinafter, also referred to as “repeating unit (1)”).

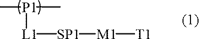

In Formula (1), P1 represents the main chain of the repeating unit, L1 represents a single bond or a divalent linking group, SP1 represents a spacer group, M1 represents a mesogen group, and T1 represents a terminal group.

Specific examples of the main chain of the repeating unit represented by P1 include groups represented by Formulae (P1-A) to (P1-D). Among these, from the viewpoints of diversity and handleability of a monomer serving as a raw material, a group represented by Formula (P1-A) is preferable.

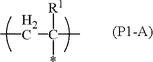

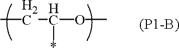

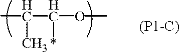

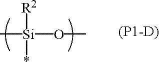

In Formulae (P1-A) to (P1-D), “*” represents a bonding position with respect to L1 in Formula (1). In Formula (P1-A), R¹ represents a hydrogen atom or a methyl group. In Formula (P1-D), R² represents an alkyl group.

From the viewpoint of further increasing the alignment degree of the light absorption anisotropic layer to be obtained, it is preferable that the group represented by Formula (P1-A) is a unit of a partial structure of poly(meth)acrylic acid ester obtained by polymerizing (meth)acrylic acid ester.

From the viewpoint of further increasing the alignment degree of the light absorption anisotropic layer to be obtained, it is preferable that the group represented by Formula (P1—B) is an ethylene glycol unit in polyethylene glycol obtained by polymerizing ethylene glycol.

From the viewpoint of further increasing the alignment degree of the light absorption anisotropic layer to be obtained, it is preferable that the group represented by Formula (P1—C) is a propylene glycol unit obtained by polymerizing propylene glycol.

From the viewpoint of further increasing the alignment degree of the light absorption anisotropic layer to be obtained, it is preferable that the group represented by Formula (P1-D) is a siloxane unit of polysiloxane obtained by polycondensation of silanol.

### L¹ Represents a Single Bond or a Divalent Linking Group

Examples of the divalent linking group represented by L1 include —C(O)O—, —OC(O)—, —O—, —S—, —C(O)NR³—, —NR³C(O)—, —SO₂—, and —NR³R⁴—. In the formulae, R³ and R⁴ each independently represent a hydrogen atom or an alkyl group having 1 to 6 carbon atoms which may have a substituent.

In a case where P1 represents a group represented by Formula (P1-A), from the viewpoint of further increasing the alignment degree of the light absorption anisotropic layer to be obtained, it is preferable that L1 represents a group represented by —C(O)O—.

In a case where P1 represents a group represented by any of Formulae (P1—B) to (P1-D), from the viewpoint of further increasing the alignment degree of the light absorption anisotropic layer to be obtained, it is preferable that L1 represents a single bond.

From the viewpoints of easily exhibiting liquid crystallinity and the availability of raw materials, it is preferable that the spacer group represented by SP1 has at least one structure selected from the group consisting of an oxyethylene structure, an oxypropylene structure, a polysiloxane structure, and an alkylene fluoride structure.

Here, as the oxyethylene structure represented by SP1, a group represented by *—(CH₂—CH₂O)ₙ₁—* is preferable. In the formula, n1 represents an integer of 1 to 20, and “*” represents a bonding position with respect to L1 or M1 in Formula (1). From the viewpoint of further increasing the alignment degree of the light absorption anisotropic layer to be obtained, n1 represents preferably an integer of 2 to 10, more preferably an integer of 2 to 4, and most preferably 3.

Further, from the viewpoint of further increasing the alignment degree of the light absorption anisotropic layer to be obtained, a group represented by *—(CH(CH₃)—CH₂O)ₙ₂—* is preferable as the oxypropylene structure represented by SP1. In the formula, n2 represents an integer of 1 to 3, and “*” represents a bonding position with respect to L1 or M1.

Further, from the viewpoint of further increasing the alignment degree of the light absorption anisotropic layer to be obtained, a group represented by *—(Si(CH₃)₂—O)ₙ₃—* is preferable as the polysiloxane structure represented by SP1. In the formula, n3 represents an integer of 6 to 10, and “*” represents a bonding position with respect to L1 or M1.

Further, from the viewpoint of further increasing the alignment degree of the light absorption anisotropic layer to be obtained, a group represented by *—(CF₂—CF₂)ₙ₄—* is preferable as the alkylene fluoride structure represented by SP1. In the formula, n4 represents an integer of 6 to 10, and “*” represents a bonding position with respect to L1 or M1.

The mesogen group represented by M1 is a group showing a main skeleton of a liquid crystal molecule that contributes to liquid crystal formation. A liquid crystal molecule exhibits liquid crystallinity which is in an intermediate state (mesophase) between a crystal state and an isotropic liquid state. The mesogen group is not particularly limited and for example, particularly description on pages 7 to 16 of “Flussige Kristalle in Tabellen II” (VEB Deutsche Verlag fur Grundstoff Industrie, Leipzig, 1984) and particularly the description in Chapter 3 of “Liquid Crystal Handbook” (Maruzen, 2000) edited by Liquid Crystals Handbook Editing Committee can be referred to.

As the mesogen group, for example, a group having at least one cyclic structure selected from the group consisting of an aromatic hydrocarbon group, a heterocyclic group, and an alicyclic group is preferable.

From the viewpoint of further increasing the alignment degree of the light absorption anisotropic layer to be obtained, the mesogen group contains preferably an aromatic hydrocarbon group, more preferably two to four aromatic hydrocarbon groups, and still more preferably three aromatic hydrocarbon groups.

From the viewpoints of exhibiting the liquid crystallinity, adjusting the liquid crystal phase transition temperature, and the availability of raw materials and synthetic suitability and from the viewpoint that the effects of the present invention are more excellent, as the mesogen group, a group represented by Formula (M1-A) or Formula (M1-B) is preferable, and a group represented by Formula (M1-B) is more preferable.

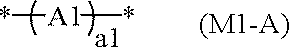

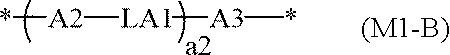

In Formula (M1-A), A1 represents a divalent group selected from the group consisting of an aromatic hydrocarbon group, a heterocyclic group, and an alicyclic group. These groups may be substituted with an alkyl group, a fluorinated alkyl group, an alkoxy group, or a substituent.

It is preferable that the divalent group represented by A1 is a 4- to 6-membered ring. Further, the divalent group represented by A1 may be a monocycle or a fused ring.

Further, “*” represents a bonding position with respect to SP1 or T1.

Examples of the divalent aromatic hydrocarbon group represented by A1 include a phenylene group, a naphthylene group, a fluorene-diyl group, an anthracene-diyl group, and a tetracene-diyl group. From the viewpoints of design diversity of a mesogenic skeleton and the availability of raw materials, a phenylene group or a naphthylene group is preferable, and a phenylene group is more preferable.

The divalent heterocyclic group represented by A1 may be any of aromatic or nonaromatic, but a divalent aromatic heterocyclic group is preferable as the divalent heterocyclic group from the viewpoint of further improving the alignment degree.

The atoms other than carbon constituting the divalent aromatic heterocyclic group include a nitrogen atom, a sulfur atom, and an oxygen atom. In a case where the aromatic heterocyclic group has a plurality of atoms constituting a ring other than carbon, these may be the same as or different from each other.

Specific examples of the divalent aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, and a thienooxazole-diyl group.

Specific examples of the divalent alicyclic group represented by A1 include a cyclopentylene group and a cyclohexylene group.

In Formula (M1-A), a1 represents an integer of 1 to 10. In a case where a1 represents 2 or greater, a plurality of A1′s may be the same as or different from each other.

In Formula (M1-B), A2 and A3 each independently represent a divalent group selected from the group consisting of an aromatic hydrocarbon group, a heterocyclic group, and an alicyclic group. Specific examples and preferred embodiments of A2 and A3 are the same as those for A1 in Formula (M1-A), and thus description thereof will not be repeated.

In Formula (M1-B), a2 represents an integer of 1 to 10. In a case where a2 represents 2 or greater, a plurality of A2′s may be the same as or different from each other, a plurality of A3′s may be the same as or different from each other, and a plurality of LA1′s may be the same as or different from each other. From the viewpoint of further increasing the alignment degree of the light absorption anisotropic layer to be obtained, a2 represents preferably an integer of 2 or greater and more preferably 2.

In Formula (M1-B), in a case where a2 represents 1, LA1 represents a divalent linking group. In a case where a2 represents 2 or greater, a plurality of LA1′s each independently represent a single bond or a divalent linking group, and at least one of the plurality of LA1′s is a divalent linking group. In a case where a2 represents 2, from the viewpoint of further increasing the alignment degree of the light absorption anisotropic layer to be obtained, it is preferable that one of the two LA1′s represents a divalent linking group and the other represents a single bond.

In Formula (M1-B), examples of the divalent linking group represented by LA1 include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent a hydrogen atom, an alkyl group having 1 to 4 carbon atoms, a cycloalkyl group, an aryl group, a cyano group, or a halogen atom), —C≡C—, —N═N—, —S—, —S(O)—, —S(O)(O)—, —(O)S(O)O—, —O(O)S(O)O—, —SC(O)—, and —C(O)S—. Among these, from the viewpoint of further increasing the alignment degree of the light absorption anisotropic layer to be obtained, —C(O)O— is preferable. LA1 may represent a group obtained by combining two or more of these groups.

Specific examples of M1 include the following structures. In the following specific examples, “Ac” represents an acetyl group.

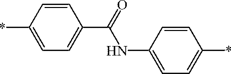 [SMILES: *c1ccc(NC(=O)c2ccc(*)cc2)cc1]

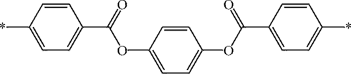 [SMILES: *c1ccc(C(=O)Oc2ccc(OC(=O)c3ccc(*)cc3)cc2)cc1]

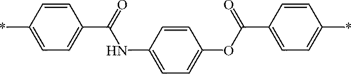 [SMILES: *c1ccc(C(=O)Nc2ccc(OC(=O)c3ccc(*)cc3)cc2)cc1]

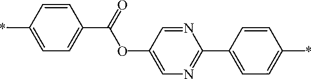 [SMILES: *c1ccc(C(=O)Oc2cnc(-c3ccc(*)cc3)nc2)cc1]

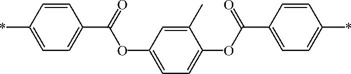 [SMILES: *c1ccc(C(=O)Oc2ccc(OC(=O)c3ccc(*)cc3)c(C)c2)cc1]

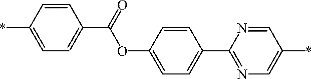 [SMILES: *c1ccc(C(=O)Oc2ccc(-c3ncc(*)cn3)cc2)cc1]

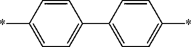 [SMILES: *c1ccc(-c2ccc(*)cc2)cc1]

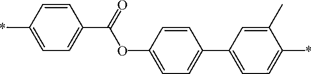 [SMILES: *c1ccc(C(=O)Oc2ccc(-c3ccc(*)c(C)c3)cc2)cc1]

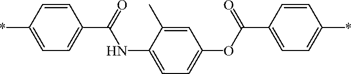 [SMILES: *c1ccc(C(=O)Nc2ccc(OC(=O)c3ccc(*)cc3)cc2C)cc1]

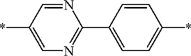 [SMILES: *c1ccc(-c2ncc(*)cn2)cc1]

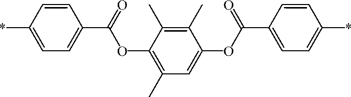 [SMILES: *c1ccc(C(=O)Oc2cc(C)c(OC(=O)c3ccc(*)cc3)c(C)c2C)cc1]

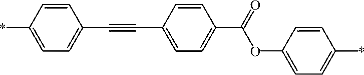 [SMILES: *c1ccc(C#Cc2ccc(C(=O)Oc3ccc(*)cc3)cc2)cc1]

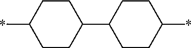 [SMILES: *C1CCC(C2CCC(*)CC2)CC1]

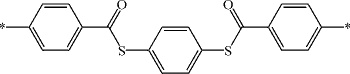 [SMILES: *c1ccc(C(=O)Sc2ccc(SC(=O)c3ccc(*)cc3)cc2)cc1]

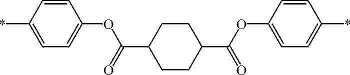 [SMILES: *c1ccc(OC(=O)C2CCC(C(=O)Oc3ccc(*)cc3)CC2)cc1]

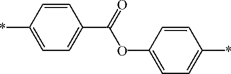 [SMILES: *c1ccc(OC(=O)c2ccc(*)cc2)cc1]

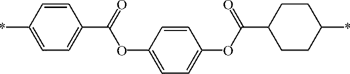 [SMILES: *c1ccc(C(=O)Oc2ccc(OC(=O)C3CCC(*)CC3)cc2)cc1]

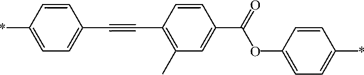 [SMILES: *c1ccc(C#Cc2ccc(C(=O)Oc3ccc(*)cc3)cc2C)cc1]

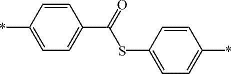 [SMILES: *c1ccc(SC(=O)c2ccc(*)cc2)cc1]

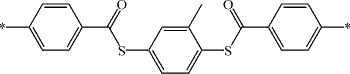 [SMILES: *c1ccc(C(=O)Sc2ccc(SC(=O)c3ccc(*)cc3)c(C)c2)cc1]

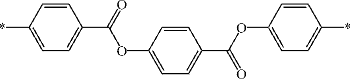 [SMILES: *c1ccc(OC(=O)c2ccc(OC(=O)c3ccc(*)cc3)cc2)cc1]

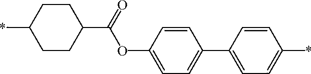 [SMILES: *c1ccc(-c2ccc(OC(=O)C3CCC(*)CC3)cc2)cc1]

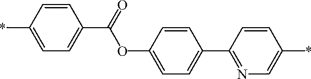 [SMILES: *c1ccc(C(=O)Oc2ccc(-c3ccc(*)cn3)cc2)cc1]

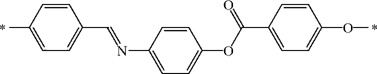

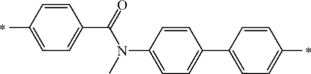

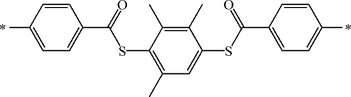

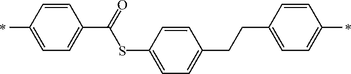

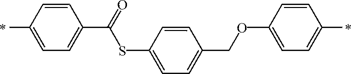

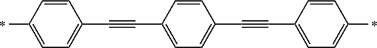

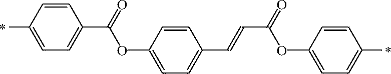

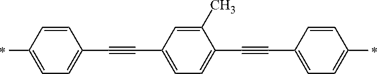

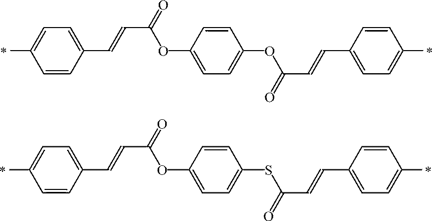

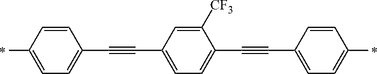

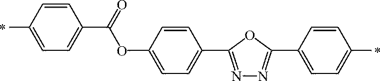

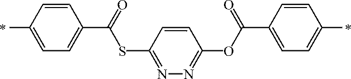

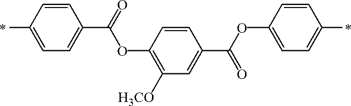

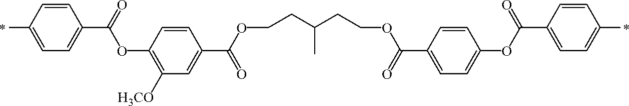

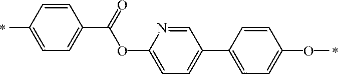

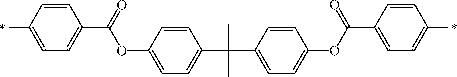

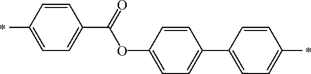

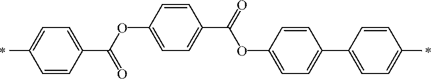

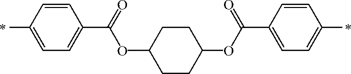

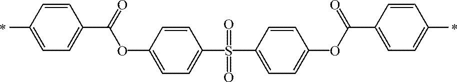

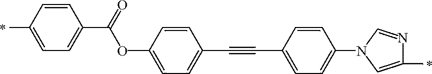

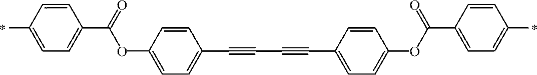

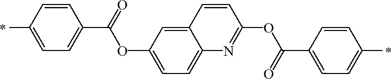

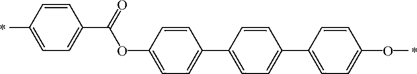

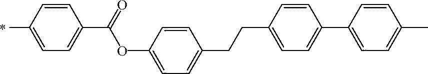

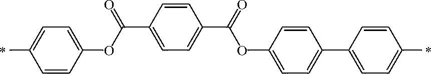

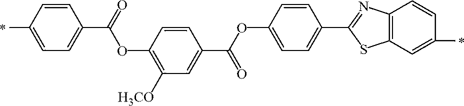

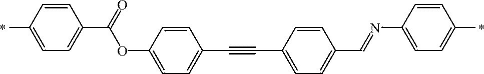

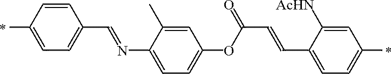

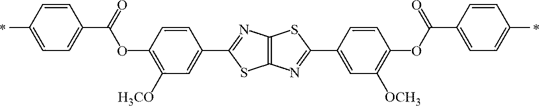

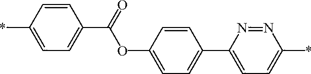 [SMILES: *c1ccc(C(=O)Oc2ccc(-c3ccc(*)nn3)cc2)cc1]

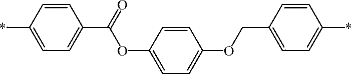 [SMILES: *c1ccc(COc2ccc(OC(=O)c3ccc(*)cc3)cc2)cc1]

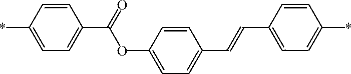 [SMILES: *c1ccc(/C=C/c2ccc(OC(=O)c3ccc(*)cc3)cc2)cc1]

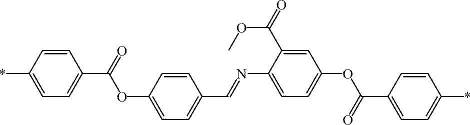 [SMILES: *c1ccc(C(=O)Oc2ccc(/C=N/c3ccc(OC(=O)c4ccc(*)cc4)cc3C(=O)OC)cc2)cc1]

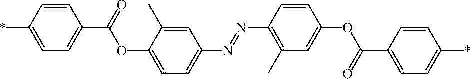 [SMILES: *c1ccc(C(=O)Oc2ccc(/N=N/c3ccc(OC(=O)c4ccc(*)cc4)c(C)c3)c(C)c2)cc1]

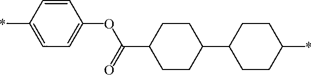 [SMILES: *c1ccc(OC(=O)C2CCC(C3CCC(*)CC3)CC2)cc1]

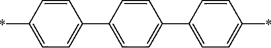 [SMILES: *c1ccc(-c2ccc(-c3ccc(*)cc3)cc2)cc1]

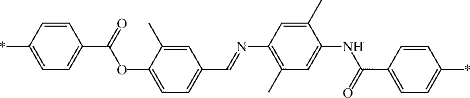 [SMILES: *c1ccc(C(=O)Nc2cc(C)c(/N=C/c3ccc(OC(=O)c4ccc(*)cc4)c(C)c3)cc2C)cc1]

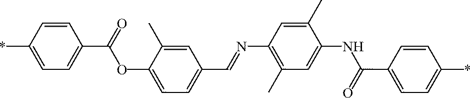 [SMILES: *c1ccc(C(=O)Nc2cc(C)c(/N=C/c3ccc(OC(=O)c4ccc(*)cc4)c(C)c3)cc2C)cc1]

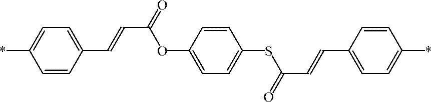 [SMILES: *c1ccc(/C=C/C(=O)Oc2ccc(SC(=O)/C=C/c3ccc(*)cc3)cc2)cc1]

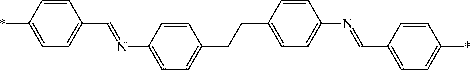 [SMILES: *c1ccc(/C=N/c2ccc(CCc3ccc(/N=C/c4ccc(*)cc4)cc3)cc2)cc1]

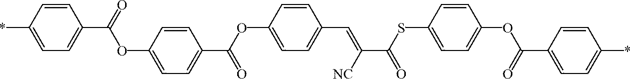

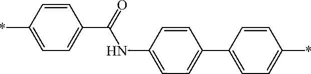 [SMILES: *c1ccc(C(=O)Nc2ccc(-c3ccc(*)cc3)cc2)cc1]

Examples of the terminal group represented by T1 include a hydrogen atom, a halogen atom, a cyano group, a nitro group, a hydroxy group, an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an alkoxycarbonyl group having 1 to 10 carbon atoms (ROC(O)-: R represents an alkyl group), an acyloxy group having 1 to 10 carbon atoms, an acylamino group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a (meth)acryloyloxy group-containing group. Examples of the (meth)acryloyloxy group-containing group include a group represented by -L-A (L represents a single bond or a linking group, specific examples of the linking group are the same as those for L1 and SP1 described above, and A represents a (meth)acryloyloxy group).

From the viewpoint of further increasing the alignment degree of the light absorption anisotropic layer to be obtained, T1 represents preferably an alkoxy group having 1 to 10 carbon atoms, more preferably an alkoxy group having 1 to 5 carbon atoms, and still more preferably a methoxy group. These terminal groups may be further substituted with these groups or the polymerizable groups described in JP2010-244038A.

From the viewpoint of further increasing the alignment degree of the light absorption anisotropic layer to be obtained, the number of atoms in the main chain of T1 is preferably in a range of 1 to 20, more preferably in a range of 1 to 15, still more preferably in a range of 1 to 10, and particularly preferably in a range of 1 to 7. In a case where the number of atoms in the main chain of T1 is 20 or less, the alignment degree of the polarizer is further improved. Here, “main chain” in T1 indicates the longest molecular chain bonded to M1, and the number of hydrogen atoms is not included in the number of atoms in the main chain of T1. For example, the number of atoms in the main chain is 4 in a case where T1 represents an n-butyl group, the number of atoms in the main chain is 3 in a case where T1 represents a sec-butyl group.

From the viewpoint of further increasing the alignment degree of the light absorption anisotropic layer to be obtained, the content of the repeating unit (1) is preferably in a range of 20% to 100% by mass with respect to 100% by mass of all the repeating units of the polymer liquid crystal compound.

In the present invention, the content of each repeating unit contained in the polymer liquid crystal compound is calculated based on the charged amount (mass) of each monomer used for obtaining each repeating unit.

The polymer liquid crystal compound may have only one or two or more kinds of the repeating units (1). Among the repeating units, from the viewpoint of further increasing the alignment degree of the light absorption anisotropic layer to be obtained, it is preferable that the polymer liquid crystal compound has two kinds of the repeating units (1).

In a case where the polymer liquid crystal compound has two kinds of the repeating units (1), from the viewpoint of further increasing the alignment degree of the light absorption anisotropic layer to be obtained, it is preferable that the terminal group represented by T1 in one unit (repeating unit A) is an alkoxy group and the terminal group represented by T1 in the other unit (repeating unit B) is a group other than the alkoxy group.

From the viewpoint of further increasing the alignment degree of the light absorption anisotropic layer to be obtained, as the terminal group represented by T1 in the repeating unit B, an alkoxycarbonyl group, a cyano group, or a (meth)acryloyloxy group-containing group is preferable, and an alkoxycarbonyl group or a cyano group is more preferable.

From the viewpoint of further increasing the alignment degree of the light absorption anisotropic layer to be obtained, the ratio (A/B) of the content of the repeating unit A in the polymer liquid crystal compound to the content of the repeating unit B in the polymer liquid crystal compound is preferably in a range of 50/50 to 95/5, more preferably in a range of 60/40 to 93/7, and still more preferably in a range of 70/30 to 90/10.

### <Repeating Unit (3-2)>

The polymer liquid crystal compound of the present invention may further have a repeating unit represented by Formula (3-2) (in the present specification, also referred to as “repeating unit (3-2)”). This provides advantages such as improvement of the solubility of the polymer liquid crystal compound in a solvent and ease of adjustment of the liquid crystal phase transition temperature.

The repeating unit (3-2) is different from the repeating unit (1) in terms that the repeating unit (3-2) does not have at least a mesogen group.

In a case where the polymer liquid crystal compound has the repeating unit (3-2), the polymer liquid crystal compound is a copolymer of the repeating unit (1) and the repeating unit (3-2) (or may be a copolymer having repeating units A and B) and may be any polymer such as a block polymer, an alternating polymer, a random polymer, or a graft polymer.

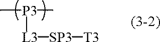

In Formula (3-2), P3 represents the main chain of the repeating unit, L3 represents a single bond or a divalent linking group, SP3 represents a spacer group, and T3 represents a terminal group.

Specific examples of P3, L3, SP3, and T3 in Formula (3-2) are the same as those for P1, L1, SP1, and T1 in Formula (1).

Here, from the viewpoint of improving the strength of the light absorption anisotropic layer, it is preferable that T3 in Formula (3-2) contains a polymerizable group.

The content of the repeating unit (3-2) is preferably in a range of 0.5% to 40% by mass and more preferably in a range of 1% to 30% by mass with respect to 100% by mass of all the repeating units of the polymer liquid crystal compound.

The polymer liquid crystal compound may have only one or two or more kinds of repeating units (3-2). In a case where the polymer liquid crystal compound has two or more kinds of repeating units (3-2), it is preferable that the total amount thereof is in the above-described ranges.

### (Weight-Average Molecular Weight)

From the viewpoint of further increasing the alignment degree of the light absorption anisotropic layer to be obtained, the weight-average molecular weight (Mw) of the polymer liquid crystal compound is preferably in a range of 1,000 to 500,000 and more preferably in a range of 2,000 to 300,000. In a case where the Mw of the polymer liquid crystal compound is in the above-described ranges, the polymer liquid crystal compound is easily handled.

In particular, from the viewpoint of suppressing cracking during the coating, the weight-average molecular weight (Mw) of the polymer liquid crystal compound is preferably 10,000 or greater and more preferably in a range of 10,000 to 300,000.

In addition, from the viewpoint of the temperature latitude of the alignment degree, the weight-average molecular weight (Mw) of the polymer liquid crystal compound is preferably less than 10,000 and more preferably 2,000 or greater and less than 10,000.

Here, the weight-average molecular weight and the number average molecular weight in the present invention are values measured according to gel permeation chromatography (GPC).
· Solvent (eluent): N-methylpyrrolidone
· Equipment name: TOSOH HLC-8220GPC
· Column: Connect and use three of TOSOH TSKgel Super AWM-H (6 mm × 15 cm)
· Column temperature: 25° C.
· Sample concentration: 0.1% by mass
· Flow rate: 0.35 mL/min
· Calibration curve: TSK standard polystyrene (manufactured by TOSOH Corporation), calibration curves of 7 samples with Mw of 2,800,000 to 1,050 (Mw/Mn = 1.03 to 1.06) are used.

### (Content)

In the present invention, the content of the liquid crystal compound is preferably in a range of 50% to 99% by mass and more preferably in a range of 70% to 96% by mass with respect to the solid content of the composition for forming a light absorption anisotropic layer.

Here, “solid content in the composition for forming a light absorption anisotropic layer” denotes components from which solvents are removed, and specific examples of the solid content include the liquid crystal compound, and a dichroic substance, a polymerization initiator, an interface improver described below.

### <Dichroic Substance>

The composition for forming a light absorption anisotropic layer contains a dichroic substance.

The dichroic substance is not particularly limited, and examples thereof include a visible light absorbing substance (dichroic coloring agent), an ultraviolet absorbing substance, an infrared absorbing substance, a non-linear optical substance, and a carbon nanotube, and known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, and paragraphs [0014] to [0034] of WO2018/164252A.

In the present invention, two or more kinds of dichroic substances may be used in combination. For example, from the viewpoint of obtaining a high polarization degree over a wider wavelength range, it is preferable that at least one dichroic substance having a maximal absorption wavelength in a wavelength range of 370 to 550 nm and at least one dichroic substance having a maximal absorption wavelength in a wavelength range of 500 to 700 nm are used in combination.

The dichroic substance may contain a crosslinkable group. In particular, from the viewpoint of suppressing a change in the polarization degree during heating, it is preferable that the dichroic substance contains a crosslinkable group.

Specific examples of the crosslinkable group include a (meth)acryloyl group, an epoxy group, an oxetanyl group, and a styryl group. Among these, a (meth)acryloyl group is preferable.

### (Content)

From the viewpoint of further increasing the alignment degree of the dichroic substance, the content of the dichroic substance in the composition for forming a light absorption anisotropic layer is preferably in a range of 1 to 400 parts by mass, more preferably in a range of 2 to 100 parts by mass, and still more preferably in a range of 5 to 30 parts by mass with respect to 100 parts by mass of the liquid crystal compound.

It is preferable that none of the liquid crystal compound and the dichroic substance described above has absorption to near-infrared light. In this manner, the influence of the light absorption anisotropic layer on various sensors incorporated in optical systems such as a virtual reality display device, an electronic viewfinder, and the like, in which near-infrared light for eye tracking, facial expression recognition, and iris recognition is used as a light source can be minimized.

### <Surfactant>

As the surfactant contained in the composition for forming a light absorption anisotropic layer, a known surfactant of the related art can be used, but a copolymer having a repeating unit containing a fluorinated alkyl group and a repeating unit having a ring structure is preferable.

In the following description, the repeating unit containing a fluorinated alkyl group will also be referred to as “repeating unit F”, and the repeating unit having a ring structure will also be referred to as “repeating unit M”.

As a Hansen solubility parameter, a value calculated by inputting a structural formula of a compound to HSPiP (Ver. 5.1.08) is employed. A dispersion element δD is an element resulting from the Van der Waals force.

In the copolymer, the δD and the volume are calculated by a structural formula in which a bonding portion of each repeating unit is substituted with a hydrogen atom, and a value averaged by the volume ratio is employed.

High-temperature aging at 80° C. to 140° C. is required to align the liquid crystal compound, and a decrease in the viscosity of the composition during the high-temperature aging may result in cissing failure.

As a result of the examination conducted by the inventors, it was found that the δD of the surfactant is correlated with the cissing failure. Specifically, the δD of the surfactant is preferably 15.5 or greater and 17.5 or less and more preferably 15.8 or greater and 17.0 or less.

### (Repeating Unit F)

It is preferable that the repeating unit F contained in the copolymer is a repeating unit represented by Formula (a).

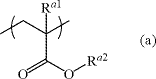

In Formula (a), R^{a1} represents a hydrogen atom or an alkyl group having 1 to 20 carbon atoms, R^{a2} represents an alkyl group having 1 to 20 carbon atoms or an alkenyl group having 2 to 20 carbon atoms, in which at least one carbon atom has a fluorine atom as a substituent.

In Formula (a), from the viewpoint of further suppressing alignment defects of the light absorption anisotropic layer to be obtained, R^{a2} represents preferably an alkyl group having 1 to 10 carbon atoms or an alkenylene group having 2 to 10 carbon atoms, in which at least one carbon atom has a fluorine atom as a substituent, more preferably an alkyl group having 1 to 10 carbon atoms, and still more preferably a group in which half or more of the carbon atoms contained in R^{a2} have a fluorine atom as a substituent.

In the present invention, it is more preferable that the repeating unit F contained in the copolymer is a repeating unit represented by Formula (b).

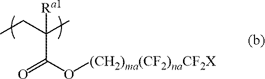

In Formula (b), R^{a1} represents a hydrogen atom or an alkyl group having 1 to 20 carbon atoms, ma and na each independently represent an integer of 0 or greater, and X represents a hydrogen atom or a fluorine atom.

Here, it is preferable that ma represents an integer of 1 or greater and 10 or less and na represents 4 or greater and 12 or less.

Specific examples of the monomer forming the repeating unit F (hereinafter, also referred to as “fluoroalkyl group-containing monomer”) of the copolymer include 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, 2-(perfluoro-3-methylbutyl)ethyl (meth)acrylate, 2-(perfluoro-5-methylhexyl)ethyl (meth)acrylate, 2-(perfluoro-7-methyloctyl)ethyl (meth)acrylate, 1H,1H,3H-tetrafluoropropyl (meth)acrylate, 1H, 1H,5H-octafluoropentyl (meth)acrylate, 1H, 1H,7H-dodecafluoroheptyl (meth)acrylate, 1H,1H,9H-hexadecafluorononyl (meth)acrylate, 1H-1-(trifluoromethyl) trifluoroethyl (meth)acrylate, 1H,1H,3H-hexafluorobutyl (meth)acrylate, 3-perfluorobutyl-2-hydroxypropyl (meth)acrylate, 3-perfluorohexyl-2-hydroxypropyl (meth)acrylate, 3-perfluorooctyl-2-hydroxypropyl (meth)acrylate, 3-(perfluoro-3-methylbutyl)-2-hydroxypropyl (meth)acrylate, 3-(perfluoro-5-methylhexyl)-2-hydroxypropyl (meth)acrylate, and 3-(perfluoro-7-methyloctyl)-2-hydroxypropyl (meth)acrylate.

In the present invention, from the viewpoints of the reactivity and the surface modification effect, the ratio of copolymerizing the fluoroalkyl group-containing monomer is preferably in a range of 0.01 to 100 mole, more preferably in a range of 0.1 to 50 mole, and still more preferably in a range of 1 to 30 mole with respect to 1 mole of the monomer containing a mesogen group described below.

### (Repeating Unit M)

The repeating unit M contained in the copolymer may be a unit having a ring structure.

The ring structure is, for example, at least one ring structure selected from the group consisting of an aromatic hydrocarbon group, a heterocyclic group, and an alicyclic group. From the viewpoint of suppressing alignment defects, it is preferable that the repeating unit M has two or more ring structures.

In the present invention, it is more preferable that the repeating unit F contained in the copolymer is a repeating unit represented by Formula (b).

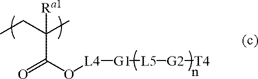

In Formula (c), R^{a1} represents a hydrogen atom or an alkyl group having 1 to 20 carbon atoms, L4 and L5 represent a single bond or an alkylene group having 1 to 8 carbon atoms, G1 and G2 represent a divalent cyclic group, and T1 represents a terminal group. n represents an integer of 0 to 4.

In regard to the alkylene group represented by L4 and L5, one or more —CH₂—’s constituting the alkylene group may be substituted with at least one group selected from the group consisting of a single bond, —O—, —S—, —NR³¹—, —C(═O)—, —C(═S)—, —CR³²═CR³²—, —C≡C—, —SiR³³R³⁴—, —N═N—, —CR³⁵═N—N═CR³⁶—, —CR³⁷═N—, and —SO₂—, and R³¹ to R³⁷ each independently represent a hydrogen atom, a halogen atom, a cyano group, a nitro group, or a linear or branched alkyl group having 1 to 10 carbon atoms.

Further, in a case where L represents an alkylene group, the hydrogen atoms contained in one or more —CH₂—’s constituting the alkylene group may be substituted with at least one group selected from the group consisting of a halogen atom, a cyano group, a nitro group, a hydroxyl group, a linear alkyl group having 1 to 10 carbon atoms, and a branched alkyl group having 1 to 10 carbon atoms.

Among these, it is preferable that L4 represents an alkyleneoxy group having 4 to 6 carbon atoms and having a terminal which is oxygen and most preferable that L5 represents an ester group.

Each divalent cyclic group represented by G1 and G2 is independently a divalent alicyclic hydrocarbon group or a divalent aromatic hydrocarbon group having 5 to 8 carbon atoms, and one or more —CH₂— constituting the alicyclic hydrocarbon group may be substituted with —O—, —S—, or —NH—. Further, a plurality of alicyclic hydrocarbon groups or aromatic hydrocarbon groups may be bonded through a single bond. Among these, a benzene ring is preferable.

Examples of the terminal group represented by T4 include a hydrogen atom, a halogen atom, a cyano group, a nitro group, a hydroxy group, an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an alkoxycarbonyl group having 1 to 10 carbon atoms (ROC(O)-: R represents an alkyl group), an acyloxy group having 1 to 10 carbon atoms, an acylamino group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a (meth)acryloyloxy group-containing group. Among these, a hydrogen atom and a cyano group are most preferable.

The molar ratio of the repeating unit F to all the repeating units is preferably 50% by mole or greater from the viewpoint of the alignment degree and preferably 70% by mole or less from the viewpoint of cissing.

### (Content)

In the present invention, from the viewpoint of further increasing the alignment degree of the light absorption anisotropic layer to be obtained, the content of the surfactant described above is preferably in a range of 0.05 to 15 parts by mass, more preferably in a range of 0.08 to 10 parts by mass, and still more preferably in a range of 0.1 to 5 parts by mass with respect to 100 parts by mass of the liquid crystal compound.

### <Polymerization Initiator>

It is preferable that the composition for forming a light absorption anisotropic layer contains a polymerization initiator.

The polymerization initiator is not particularly limited, but a compound having photosensitivity, that is, a photopolymerization initiator is preferable.

As the photopolymerization initiator, various compounds can be used without any particular limitation. Examples of the photopolymerization initiator include α-carbonyl compounds (US2367661A and US2367670A), acyloin ether (US2448828A), α-hydrocarbon-substituted aromatic acyloin compounds (US2722512A), polynuclear quinone compounds (US3046127A and US2951758A), a combination of a triarylimidazole dimer and a p-aminophenyl ketone (US3549367A), acridine and phenazine compounds (JP1985-105667A (JP-S60-105667A) and US4239850A), oxadiazole compounds (US4212970A), o-acyloxime compounds (paragraph [0065] of JP2016-27384A), and acylphosphine oxide compounds (JP1988-40799B (JP-S63-40799B), JP1993-29234B (JP-H05-29234B), JP1998-95788A (JP-H10-95788A), and JP1998-29997A (JP-H10-29997A)).

As such a photopolymerization initiator, a commercially available product can also be used. Examples of commercially available products of the photopolymerization initiator include IRGACURE 184, IRGACURE 907, IRGACURE 369, IRGACURE 651, IRGACURE 819, IRGACURE OXE-01, and IRGACURE OXE-02 (all manufactured by BASF SE).

In a case where the composition for forming a light absorption anisotropic layer contains a polymerization initiator, the content of the polymerization initiator is preferably in a range of 0.01 to 30 parts by mass and more preferably in a range of 0.1 to 15 parts by mass with respect to 100 parts by mass of the total amount of the dichroic substance and the polymer liquid crystal compound in the composition for forming a light absorption anisotropic layer. The durability of the light absorption anisotropic film is enhanced in a case where the content of the polymerization initiator is 0.01 parts by mass or greater, and the alignment degree of the light absorption anisotropic film is enhanced in a case where the content thereof is 30 parts by mass or less.

The polymerization initiator may be used alone or in combination of two or more kinds thereof. In a case where the composition contains two or more kinds of polymerization initiators, it is preferable that the total amount of the polymerization initiators is in the above-described ranges.

### <Solvent>

From the viewpoint of workability, it is preferable that the composition for forming a light absorption anisotropic layer according to the present invention contains a solvent.

Examples of the solvent include organic solvents such as ketones (such as acetone, 2-butanone, methyl isobutyl ketone, cyclopentanone, and cyclohexanone), ethers (such as dioxane, tetrahydrofuran, 2-methyltetrahydrofuran, cyclopentyl methyl ether, tertrahydropyran, and dioxolanes), aliphatic hydrocarbons (such as hexane), alicyclic hydrocarbons (such as cyclohexane), aromatic hydrocarbons (such as benzene, toluene, xylene, and trimethylbenzene), halogenated carbons (such as dichloromethane, trichloromethane, dichloroethane, dichlorobenzene, and chlorotoluene), esters (such as methyl acetate, ethyl acetate, butyl acetate, and ethyl lactate), alcohols (such as ethanol, isopropanol, butanol, cyclohexanol, isopentyl alcohol, neopentyl alcohol, diacetone alcohol, and benzyl alcohol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, and N-ethylpyrrolidone), and heterocyclic compounds (such as pyridine), and water. These solvents may be used alone or in combination of two or more kinds thereof.

Among these solvents, from the viewpoint of exhibiting the effect of the excellent solubility, ketones (particularly cyclopentanone and cyclohexanone), ethers (particularly tetrahydrofuran, cyclopentyl methyl ether, tetrahydropyran, and dioxolane), and amides (particularly dimethylformamide, dimethylacetamide, N-methylpyrrolidone, and N-ethylpyrrolidone) are preferable.

In a case where the composition for forming a light absorption anisotropic layer contains a solvent, the content of the solvent is preferably in a range of 80% to 99% by mass, more preferably in a range of 83% to 97% by mass, and particularly preferably in a range of 85% to 95% by mass with respect to the total mass of the composition for forming a light absorption anisotropic layer.

These solvents may be used alone or in combination of two or more kinds thereof. In a case where the composition contains two or more kinds of solvents, it is preferable that the total amount of the solvents is in the above-described range.

### <Method of Forming Light Absorption Anisotropic Layer>

A method of forming a light absorption anisotropic layer is not particularly limited, and examples thereof include a method including a step of coating the photo-alignment layer with a composition for forming the light absorption anisotropic layer to form a coating film and a step of aligning the liquid crystal component and the dichroic substance contained in the coating film in this order. In the description below, the step of forming a coating film will also be referred to as “coating film forming step”, and the step of aligning the liquid crystal component and the dichroic substance will also be referred to as “aligning step”.

Further, the liquid crystal component is a component that also contains a dichroic substance having liquid crystallinity in a case where the above-described dichroic substance has liquid crystallinity, in addition to the above-described liquid crystal compound.

### (Coating Film Forming Step)

The coating film forming step is a step of coating a photo-alignment layer with a composition for forming a light absorption anisotropic layer to form a coating film.

The photo-alignment layer is easily coated with the composition for forming a light absorption anisotropic layer by using the composition for forming a light absorption anisotropic layer containing the solvent described above or using a liquid-like material such as a melt obtained by heating the composition for forming a light absorption anisotropic layer.

Examples of the method of coating the layer with the composition for forming a light absorption anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

### (Aligning Step)

The aligning step is a step of aligning the liquid crystal component contained in the coating film. In this manner, a light absorption anisotropic layer is obtained.

The aligning step may include a drying treatment. Components such as a solvent can be removed from the coating film by performing the drying treatment. The drying treatment may be performed according to a method of allowing the coating film to stand at room temperature for a predetermined time (for example, natural drying) or a method of heating the coating film and/or blowing air to the coating film.

Here, the liquid crystal component contained in the composition for forming a light absorption anisotropic layer may be aligned by the coating film forming step or the drying treatment described above. For example, in an aspect in which the composition for forming a light absorption anisotropic layer is prepared as a coating solution containing a solvent, a coating film having light absorption anisotropy (that is, a light absorption anisotropic film) is obtained by drying the coating film and removing the solvent from the coating film.

In a case where the drying treatment is performed at a temperature higher than or equal to the transition temperature of the liquid crystal component contained in the coating film to the liquid crystal phase, the heat treatment described below may not be performed.

The transition temperature of the liquid crystal component contained in the coating film to the liquid crystal phase is preferably in a range of 10° C. to 250° C. and more preferably in a range of 25° C. to 190° C. from the viewpoint of the manufacturing suitability or the like. It is preferable that the transition temperature is 10° C. or higher from the viewpoint that a cooling treatment or the like for lowering the temperature to a temperature range in which a liquid crystal phase is exhibited is not necessary. Further, it is preferable that the transition temperature is 250° C. or lower from the viewpoint that a high temperature is not required even in a case of setting an isotropic liquid state at a temperature higher than the temperature range in which a liquid crystal phase is temporarily exhibited, and waste of thermal energy and deformation and deterioration of a substrate can be reduced.

It is preferable that the aligning step includes a heat treatment. In this manner, since the liquid crystal component contained in the coating film can be aligned, the coating film after being subjected to the heat treatment can be suitably used as the light absorption anisotropic film.

From the viewpoint of the manufacturing suitability, the heat treatment is performed at a temperature of preferably 10° C. to 250° C. and more preferably 25° C. to 190° C. Further, the heating time is preferably in a range of 1 to 300 seconds and more preferably in a range of 1 to 60 seconds.

The aligning step may include a cooling treatment performed after the heat treatment. The cooling treatment is a treatment of cooling the coating film after being heated to room temperature (20° C. to 25° C.). In this manner, the alignment of the liquid crystal component contained in the coating film can be fixed. The cooling means is not particularly limited and can be performed according to a known method.

The light absorption anisotropic film can be obtained by performing the above-described steps.

In the present aspect, examples of the method of aligning the liquid crystal components contained in the coating films include a drying treatment and a heat treatment, but the method is not limited thereto, and the liquid crystal components can be aligned by a known alignment treatment.

### (Other Steps)

The method of forming the light absorption anisotropic layer may include a step of curing the light absorption anisotropic layer after the aligning step. In the description below, this step will also be referred to as “curing step”.

The curing step is performed by heating the light absorption anisotropic layer and/or irradiating the layer with light (exposing the layer to light), for example, in a case where the light absorption anisotropic layer contains a crosslinkable group (polymerizable group). Between these, it is preferable that the curing step is performed by irradiating the layer with light.

Various kinds of light such as infrared rays, visible light, and ultraviolet rays can be used as the light for curing, but ultraviolet rays are preferable. In addition, ultraviolet rays may be applied while the layer is heated during curing, or ultraviolet rays may be applied through a filter that transmits only a specific wavelength.

In a case where irradiation with light is performed while the layer is heated, the heating temperature during the irradiation with light depends on the transition temperature of the liquid crystal components contained in the liquid crystal film to a liquid crystal phase, but is preferably in a range of 25° to 10° C.

Further, the irradiation with light may be performed in a nitrogen atmosphere. In a case where the curing of the liquid crystal film proceeds by radical polymerization, from the viewpoint of reducing inhibition of polymerization by oxygen, it is preferable that the irradiation with light is performed in a nitrogen atmosphere.

### Other Functional Layers

The laminated optical film according to the embodiment of the present invention may have other functional layers in addition to the reflective circular polarizer, the retardation layer, and the linear polarizer.

In addition, it is preferable that other functional layers are transparent to near-infrared light in order to minimize the influence on various sensors incorporated in optical systems such as a virtual reality display device, an electronic viewfinder, and the like, in which near-infrared light for eye tracking, facial expression recognition, and iris recognition is used as a light source.

### <Positive C-Plate>

It is also preferable that the laminated optical film according to the embodiment of the present invention further includes a positive C-plate. Here, the positive C-plate is a retardation layer in which the in-plane retardation Re is substantially zero and the retardation Rth in the thickness direction has a negative value.

The positive C-plate can be obtained, for example, by vertically aligning a rod-like liquid crystal compound. For details of a method of producing the positive C-plate, for example, the description in JP2017-187732A, JP2016-53709A, and JP2015-200861A can be referred to.

The positive C-plate functions as an optical compensation layer for increasing the polarization degree of transmitted light and reflected light with respect to light incident obliquely. One or a plurality of the positive C-plates may be provided at any position of the laminated optical film.

The positive C-plate may be disposed adjacent to the reflective circular polarizer or inside the reflective circular polarizer.

In a case where, for example, a light reflecting layer formed by immobilizing a cholesteric liquid crystalline phase containing a rod-like liquid crystal compound is used as the reflective circular polarizer, the light reflecting layer has a positive retardation Rth in the thickness direction. Here, in a case where light is incident on the reflective circular polarizer in an oblique direction, the polarization states of the reflected light and the transmitted light may change due to the action of the retardation Rth, and the polarization degrees of the reflected light and the transmitted light may decrease.

On the contrary, it is preferable that the positive C-plate is provided inside the reflective circular polarizer and/or in the vicinity thereof from the viewpoint that a change in the polarization state of the oblique incidence ray is suppressed and a decrease in the polarization degrees of the reflected light and the transmitted light can be suppressed.

According to the examination conducted by the present inventors, it is preferable that the positive C-plate is disposed on a surface of the blue light reflecting layer on a side opposite to the green light reflecting layer, but the positive C-plate may be disposed at another place. The in-plane retardation Re of the positive C-plate in this case is preferably approximately 10 nm or less, and the retardation Rth thereof in the thickness direction is preferably in a range of -600 nm to -100 nm and more preferably in a range of -400 nm to -200 nm.

Further, the positive C-plate may be disposed adjacent to the retardation layer or inside the retardation layer.

In a case where, for example, a layer formed by immobilizing a rod-like liquid crystal compound is used as the retardation layer, the retardation layer has a positive retardation Rth in the thickness direction. Here, in a case where light is incident on the retardation layer in an oblique direction, the polarization states of the transmitted light may change due to the action of the retardation Rth in the thickness direction, and the polarization degree of the transmitted light may decrease.

On the contrary, it is preferable that the positive C-plate is provided inside the retardation layer and/or in the vicinity thereof from the viewpoint that a change in the polarization state of the oblique incidence ray is suppressed and a decrease in the polarization degree of the transmitted light can be suppressed.

According to the examination conducted by the present inventors, it is preferable that the positive C-plate is disposed on a surface of the retardation layer on a side opposite to the linear polarizer, but the positive C-plate may be disposed at another place. The in-plane retardation Re of the positive C-plate in this case is preferably approximately 10 nm or less, and the retardation Rth thereof in the thickness direction is preferably in a range of -90 nm to -40 nm.

Further, the positive C-plate may include supports which are the same as the retardation layer, the linear polarizer, and the like described above.

### <Antireflection Layer>

It is also preferable that the laminated optical film according to the embodiment of the present invention includes an antireflection layer on a surface thereof.

The laminated optical film according to the embodiment of the present invention has a function of reflecting specific circularly polarized light and transmitting circularly polarized light orthogonal to the specific circularly polarized light, and the reflection on a surface of the laminated optical film typically includes unintended reflection of polarized light, which leads to a decrease in the polarization degrees of the transmitted light and the reflected light. Therefore, it is preferable that the laminated optical film includes an antireflection layer on a surface thereof.

The antireflection layer may be provided only on one surface or on both surfaces of the laminated optical film.

The kind of the antireflection layer is not particularly limited, but a moth-eye film, an AR film, or the like is preferable from the viewpoint of further decreasing the reflectivity. Further, in a case where the laminated optical film is stretched or molded, a moth-eye film is preferable from the viewpoint that high antireflection performance can be maintained even in a case of fluctuation in the film thickness due to the stretching. Meanwhile, an AR film is preferable from the viewpoint of satisfactory wiping properties in a case where stains are attached to the surface of the antireflection layer and difficulties in handling, such as breakage of the microstructure of the surface, are less likely to occur.

Further, in a case where the antireflection layer includes a support and stretching, molding, or the like is performed, from the viewpoint of facilitating stretching, molding, or the like, the support has a Tg peak temperature of preferably 170° C. or lower and more preferably 130° C. or lower. Specifically, for example, a PMMA film or the like is preferable.

### <Second Retardation Layer>

It is also preferable that the laminated optical film according to the embodiment of the present invention further includes a second retardation layer. For example, the laminated optical film according to the embodiment of the present invention may include a reflective circular polarizer, a retardation layer, a linear polarizer, and a second retardation layer in this order.

It is preferable that the second retardation layer converts linearly polarized light into circularly polarized light, and for example, a retardation layer having an in-plane retardation Re of a ¼ wavelength is preferable. The reason for this will be described below.

Light that is incident on the laminated optical film from the side of the reflective circular polarizer and transmitted through the reflective circular polarizer, the retardation layer, and the linear polarizer has been converted into linearly polarized light, and a part of the light is reflected on the outermost surface on the side of the linear polarizer and emitted from the surface on the side of the reflective circular polarizer again. Such light is extra reflected light and may decrease the polarization degree of the reflected light, and thus it is preferable that the amount of such light is reduced. Therefore, a method of laminating an antireflection layer may be considered to suppress reflection on the outermost surface on the side of the linear polarizer, but in a case where the laminated optical film is used by being bonded to a medium such as glass or plastic, the antireflection effect cannot be obtained because reflection on the surface of the medium cannot be suppressed even in a case where the antireflection layer is provided on the bonding surface of the laminated optical film.

Meanwhile, in a case where the second retardation layer that converts linearly polarized light into circularly polarized light is provided, light that reaches the outermost surface on the side of the linear polarizer is converted into circularly polarized light and converted into circularly polarized light orthogonal to each other in a case of reflection on the outermost surface of the medium. Thereafter, in a case where the light is transmitted through the second retardation layer again and reaches the linear polarizer, the light is converted into linearly polarized light in the absorption axis azimuth of the linear polarizer and absorbed by the linear polarizer. Therefore, it is possible to prevent extra reflection.

From the viewpoint of more effectively suppressing the extra reflection, it is preferable that the second retardation layer has substantially reverse dispersibility.

### <Support>

The laminated optical film according to the embodiment of the present invention may further include a support.

The support can be disposed at any place.

The support may be a support that constitutes each layer such as the reflective circular polarizer, the retardation layer, the linear polarizer, the positive C-plate, and the antireflection layer constituting the laminated optical film according to the embodiment of the present invention described above or may be a support that is separately added to support the laminated optical film.

Further, for example, in a case where one or more of the reflective circular polarizer, the retardation layer, the linear polarizer, the positive C-plate, the antireflection layer, and the like are films used by being transferred from the temporary support, the support can be used as a transfer destination thereof.

The kind of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, and polyester. Among these, a cellulose acylate film, cyclic polyolefin, polyacrylate, polymethacrylate, and the like are preferable. In addition, commercially available cellulose acetate films (for example, “TD80U” and “Z-TAC”, manufactured by FUJIFILM Corporation) and the like can also be used as the support.

In addition, it is preferable that the support has a small retardation from the viewpoint of suppressing an adverse effect on the polarization degrees of the transmitted light and the reflected light and from the viewpoint of facilitating the optical inspection of the laminated optical film. Specifically, the magnitude of the Re is preferably 10 nm or less, and the absolute value of the magnitude of the Rth is preferably 50 nm or less.

In a case where the laminated optical film according to the embodiment of the present invention is stretched, molded, or the like, such as molding according to the shape of a lens to be combined, it is preferable that the support has a tan δ (loss tangent (loss factor)) peak temperature of 170° C. or lower.

From the viewpoint that the laminated optical film can be molded at a low temperature, the support has a tan δ peak temperature of preferably 150° C. or lower and more preferably 130° C. or lower.

As described above, since the laminated optical film according to the embodiment of the present invention includes a cholesteric liquid crystal layer as the light reflecting layer of the reflective circular polarizer, the reflective circular polarizer does not have an optical axis, and thus a decrease in the polarization degree due to the stretching, molding, or the like is unlikely to occur.

Further, in the laminated optical film according to the embodiment of the present invention, as a preferable aspect, the reflective circular polarizer includes a cholesteric liquid crystal layer consisting of a rod-like liquid crystal compound and a cholesteric liquid crystal layer consisting of a disk-like compound as light reflecting layers, and thus the polarization degrees of reflected light and transmitted light can be improved.

Further, as a preferable aspect, the laminated optical film according to the embodiment of the present invention includes the positive C-plate, and thus the polarization degrees of reflected light and transmitted light can be similarly improved.

Typically in optical applications, a resin base material subjected to a stretching treatment is frequently used, and the tan δ peak temperature is frequently increased due to the stretching treatment. For example, a triacetyl cellulose (TAC) base material (for example, TG40, manufactured by FUJIFILM Corporation) has a tan δ peak temperature of 180° C. or higher.

Here, in a case where the laminated optical film is stretched, molded, or the like, it is necessary to heat the laminated optical film to a temperature higher than the glass transition temperature (Tg) of the support to perform the molding or the like. In a case where the heating temperature for molding is high, each layer constituting the laminated optical film, particularly the retardation layer and the linear polarizer, may be deteriorated.

For example, in a case where the retardation layer is deteriorated, the conversion from circularly polarized light to linearly polarized light and conversion from linearly polarized light to circularly polarized light cannot be properly made. In addition, in a case where the linear polarizer is deteriorated, linearly polarized light is transmitted in a direction in which the light should not be transmitted originally.

As a result, the polarization degree of light reflected and transmitted by the laminated optical film is decreased, leakage light is generated, and ghosts and stray light are generated.

On the contrary, the laminated optical film can be molded or the like at a relatively low temperature by using a support having a tan δ peak temperature of 170° C. or lower, and thus deterioration of the retardation layer, the linear polarizer, and the like can be prevented.

That is, high polarization degrees of the reflected light and the transmitted light can be maintained even in a case where the laminated optical film is stretched, molded, or the like by using a support having a tan δ peak temperature of 170° C. or lower.

Here, a method of measuring tan δ will be described.

The loss elastic modulus E” and the storage elastic modulus E’ of a film sample that has been humidity-adjusted in advance in an atmosphere of a temperature of 25° C. and a relative humidity of 60% RH for 2 hours or longer are measured under the following conditions using a dynamic viscoelasticity measuring device (DVA-200, manufactured by IT Measurement & Control Co., Ltd.), and the values are used to acquire tan δ (= E”/E’).
Device: DVA-200, manufactured by IT Measurement & Control Co., Ltd.
Sample: 5 mm, length of 50 mm (gap of 20 mm)
Measurement conditions: tension mode
Measurement temperature: -150° C. to 220° C.
Heating conditions: 5° C./min
Frequency: 1 Hz

The support having a tan δ peak temperature of 170° C. or lower is not particularly limited, and various resin base materials can be used.

Examples thereof include polyolefin such as polyethylene, polypropylene, or a norbornene-based polymer; a cyclic olefin-based resin; polyvinyl alcohol; polyethylene terephthalate; an acrylic resin such as polymethacrylic acid ester or polyacrylic acid ester; polyethylene naphthalate; polycarbonate; polysulfone; polyethersulfone; polyetherketone; and polyphenylene sulfide, and polyphenylene oxide.

Among these, from the viewpoints of the availability on the market and excellent transparency, a cyclic olefin-based resin, polyethylene terephthalate, an acrylic resin, and the like are preferably exemplified, and a cyclic olefin-based resin, polymethacrylic acid ester, and the like are particularly preferably exemplified.

Further, from the viewpoint of durability of the laminated optical film, the tan δ peak temperature of the support is preferably 80° C. or higher.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (TOYOBO CO., LTD.), ESCENA and SCA40 (Sekisui Chemical Co., Ltd.), a ZEONOR Film (ZEON CORPORATION), and an Arton Film (JSR Corporation).

The thickness of the support is not particularly limited, but is preferably in a range of 5 to 300 µm, more preferably in a range of 5 to 100 µm, and still more preferably in a range of 5 to 30 µm.

As described above, the laminated optical film according to the embodiment of the present invention includes the reflective circular polarizer, the retardation layer, and the linear polarizer in this order, and the surface roughness Ra of the image incident surface, that is, the surface of the reflective circular polarizer on a side opposite to the linear polarizer is 100 nm or less.

In the laminated optical film according to the embodiment of the present invention, since the surface roughness Ra of the image incident surface is set to 100 nm or less, an image having high sharpness can be displayed in a case where the laminated optical film is used in an image display device such as a virtual reality display device as described above.

Here, as described above, the surface roughness Ra of the image incident surface is a value obtained by superimposing the unevenness of each layer constituting the laminated optical film, and in a case where the laminated optical film includes a support, the unevenness of the support greatly affects the surface roughness Ra of the image incident surface. That is, in the laminated optical film according to the embodiment of the present invention, the surface roughness Ra of the image incident surface can be suitably set to 100 nm or less by using a support with less unevenness.

Therefore, in a case where the laminated optical film according to the embodiment of the present invention includes a support, it is preferable that the surface roughness Ra of the support is small. Specifically, the surface roughness Ra of the support is preferably 50 nm or less, more preferably 30 nm or less, and still more preferably 20 nm or less.

The laminated optical film according to the embodiment of the present invention may include a plurality of supports. However, as described above, in consideration of the surface roughness Ra of the image incident surface, the number of supports is preferably as small as possible, preferably two or less, and particularly preferably one.

Further, from the same viewpoint as described above, it is preferable that the laminated optical film according to the embodiment of the present invention does not include a support in a case where the entire film can be supported.

### Method of Bonding Each Layer

The laminated optical film according to the embodiment of the present invention is a laminate consisting of a plurality of layers. Each layer can be bonded by an optional bonding method. As a bonding layer used to bond each other, for example, a pressure sensitive adhesive, an adhesive, or the like can be used.

As the pressure sensitive adhesive, a commercially available pressure sensitive adhesive can be optionally used.

From the viewpoint of reducing the thickness of the laminated optical film and reducing the surface roughness Ra of the image incident surface of the laminated optical film, the thickness of the pressure sensitive adhesive is preferably 25 µm or less, more preferably 15 µm or less, and still more preferably 6 µm or less. In addition, a pressure sensitive adhesive that is unlikely to generate outgas is preferable as the pressure sensitive adhesive. Particularly in a case where the laminated optical film is stretched, molded, or the like, a vacuum process, a heating process, or the like may be performed, and it is preferable that no outgas is generated even under such conditions.

A commercially available adhesive or the like can be optionally used as the adhesive, and for example, an epoxy resin-based adhesive, an acrylic resin-based adhesive, or the like can be used.

From the viewpoint of reducing the thickness of the laminated optical film and reducing the surface roughness Ra of the image incident surface of the laminated optical film, the thickness of the adhesive is preferably 25 µm or less, more preferably 5 µm or less, and still more preferably 1 µm or less. Further, from the viewpoint of reducing the thickness of the adhesive layer and coating an adherend with the adhesive such that the thickness thereof is uniform, the viscosity of the adhesive is preferably 300 cP or less, more preferably 100 cP or less, and still more preferably 10 cP or less.

Further, in a case where the adherend has surface unevenness, from the viewpoint of reducing the surface roughness Ra of the laminated optical film, the appropriate viscoelasticity or the appropriate thickness of the pressure sensitive adhesive and the adhesive can be selected so that the surface unevenness of the layer to be bonded can be embedded. From the viewpoint of embedding the surface unevenness, it is preferable that the pressure sensitive adhesive and the adhesive have a viscosity of 50 cP or greater. Further, it is preferable that the thickness of the pressure sensitive adhesive and the thickness of the adhesive are greater than the height of the surface unevenness.

Examples of the method of adjusting the viscosity of the adhesive and the viscosity of the pressure sensitive adhesive include a method of using an adhesive and a pressure sensitive adhesive which contain a solvent. In this case, the viscosity of the adhesive can be adjusted by the proportion of the solvent. Further, the thickness of the adhesive can be further reduced by drying the solvent after coating the adherend with the adhesive.

In the laminated optical film, from the viewpoint of reducing extra reflection and suppressing a decrease in the polarization degree of the transmitted light and the reflected light, it is preferable that the pressure sensitive adhesive and the adhesive used for bonding each layer have a small difference in the refractive index with an adjacent layer. Specifically, the difference in the refractive index between the pressure sensitive adhesive or the adhesive and an adjacent layer is preferably 0.05 or less and more preferably 0.01 or less. The refractive indices of the pressure sensitive adhesive and the adhesive can be adjusted, for example, by mixing fine particles of titanium oxide, fine particles of zirconia, and the like.

In addition, the reflective circular polarizer, the retardation layer, and the linear polarizer have in-plane refractive index anisotropy, but the difference in refractive index between the pressure sensitive adhesive or the adhesive and an adjacent layer is preferably 0.05 or less in all in-plane directions. Therefore, the pressure sensitive adhesive and the adhesive may have in-plane refractive index anisotropy.

In addition, it is also preferable that the bonding layer between the layers has a thickness of 100 nm or less.

In a case where the thickness of the bonding layer is 100 nm or less, the light in the visible region is not affected by the difference in refractive index, and extra reflection can be suppressed. The thickness of the bonding layer is more preferably 50 nm or less.

Examples of a method of forming the bonding layer having a thickness of 100 nm or less include a method of vapor-depositing a ceramic adhesive such as silicon oxide (SiOx layer) on the bonding surface. The bonding surface of a bonding member can be subjected to a surface modification treatment such as a plasma treatment, a corona treatment, or a saponification treatment before the bonding, and a primer layer can be applied thereto. Further, in a case where a plurality of bonding surfaces are present, the kind, the thickness, and the like of the bonding layer can be adjusted for each bonding surface.

Specifically, for example, the bonding layer having a thickness of 100 nm or less can be provided by the procedures (1) to (3) described below.

A layer to laminate is bonded to a temporary support consisting of a glass base material.

A SiOx layer having a thickness of 100 nm or less is formed on both the surface of the layer to laminate and the surface of the layer to be laminated by vapor deposition or the like. The vapor deposition can be carried out by, for example, a vapor deposition device (model number ULEYES, manufactured by ULVAC, Inc.) using SiOx powder as a vapor deposition source. In addition, it is preferable that the surface of the formed SiOx layer is subjected to a plasma treatment.

After the formed SiOx layers are bonded to each other, the temporary support is peeled off. It is preferable that the bonding is performed, for example, at a temperature of 120° C.

The coating of each layer with the adhesive and the pressure sensitive adhesive, the formation and the bonding of the bonding layer such as a SiOx layer, and the like may be performed by roll-to-roll or using a single wafer.

The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special bonding method in which the thickness of the bonding layer is 100 nm or less can be selected.

Further, examples of the method of coating an adherend with an adhesive and a pressure sensitive adhesive include known methods such as a roll coating method, a gravure printing method, a spin coating method, a wire bar coating method, an extrusion coating method, a direct gravure coating method, a reverse gravure coating method, a die coating method, a spraying method, and an ink jet method.

### Direct Application of Each Layer

It is also preferable that no bonding layer is provided between the layers of the laminated optical film according to the embodiment of the present invention. In a case of forming a layer, the bonding layer can be eliminated by directly coating an adjacent layer that has already been formed.

Further, in a case where one or both adjacent layers are layers containing a liquid crystal compound, it is preferable that the alignment direction of the liquid crystal compound is continuously changed at the interface in order to reduce the difference in refractive index in all in-plane directions. For example, the linear polarizer containing a liquid crystal compound and a dichroic substance is directly coated with a composition for forming a retardation layer containing a liquid crystal compound, and the liquid crystal compound of the retardation layer can be aligned in the alignment direction to be continuous with the linear polarizer at the interface using an alignment restricting force of the liquid crystal compound of the linear polarizer.

### Lamination Order of Each Layer

The laminated optical film according to the embodiment of the present invention consists of a plurality of layers, and the order of the steps of laminating the plurality of layers is not particularly limited and can be optionally selected.

For example, in a case where a functional layer is transferred from a film consisting of a temporary support and a functional layer, occurrence of wrinkles and cracks during the transfer can be prevented by adjusting the laminating order such that the thickness of the film at the transfer destination reaches 10 µm or greater.

Further, in a case where another layer is laminated on a layer having large surface unevenness, the surface unevenness may be further amplified, and thus it is preferable that the layers are laminated in order from a layer having a smaller surface roughness Ra from the viewpoint of reducing the surface roughness Ra of the image incident surface of the laminated optical film.

Further, from the viewpoint of quality evaluation in the step of preparing the laminated optical film, the laminating order can also be selected. For example, layers excluding the reflective circular polarizer are laminated, the quality evaluation is performed using a transmission optical system, the reflective circular polarizer is laminated, and the quality evaluation is performed using a reflection optical system.

In addition, from the viewpoint of improving the production yield of the laminated optical film and reducing the cost, it is also possible to select the laminating order.

### Applications of Laminated Optical Film According to Embodiment of Present Invention

The laminated optical film according to the embodiment of the present invention can be suitably used as a reflective polarizer to be incorporated in an image display device such as an in-vehicle room mirror, a virtual reality display device, an augmented reality display device, a mixed reality display device, an electronic viewfinder, or an aerial image display device, for example, as described in JP2017-227720A, JP1995-120679A (JP-H7-120679A), and JP2018-092135A.

Particularly in a virtual reality display device, an electronic viewfinder, or the like that has a reciprocating optical system allowing light to be reflected between the reflective polarizer and the half mirror to reciprocate the light, the laminated optical film according to the embodiment of the present invention is extremely useful from the viewpoint of improving the sharpness of a display image. In addition, since a virtual reality display device, an electronic viewfinder, or the like that has a reciprocating optical system includes an optical film such as an absorption type polarizer or a circular polarizer in addition to the reflective polarizer in some cases, the sharpness of a display image can be further improved by applying some of the members, the bonding methods, and the like used for the laminated optical film according to the embodiment of the present invention to the optical film other than the reflective polarizer described above.

### EXAMPLES

Hereinafter, the features of the present invention will be described in more detail with reference to the following examples. The materials, the used amounts, the ratios, the treatment contents, the treatment procedures, and the like described in the following examples can be appropriately changed without departing from the gist of the present invention. In addition, configurations other than the configurations described below can be employed without departing from the gist of the present invention.

### Preparation of Reflective Circular Polarizer 1

A polyethylene terephthalate (PET) film (A4100, manufactured by Toyobo Co., Ltd.) having a thickness of 50 µm was prepared as a temporary support. This PET film has an easy-adhesion layer on one surface.

The composition shown below was stirred and dissolved in a container maintained at a temperature of 70° C., thereby preparing coating solutions Ch-A, Ch-B, and Ch-C for light reflecting layers.

Coating solution Ch-A for light reflecting layer
Methyl ethyl ketone: 120.9 parts by mass
Cyclohexanone: 21.3 parts by mass
Mixture of rod-like liquid crystal compounds shown below: 100.0 parts by mass
Photopolymerization initiator B: 1.00 parts by mass
Chiral agent A shown below: 2.50 parts by mass
Surfactant F1 shown below: 0.027 parts by mass
Surfactant F2 shown below: 0.067 parts by mass

### (Coating Solution Ch-B for Light Reflecting Layer)

The coating solution Ch-B for a light reflecting layer was prepared in the same manner as that for the coating solution Ch-A for a light reflecting layer except that the content of the chiral agent A was set to 3.50 parts by mass.

### (Coating Solution Ch-C for Light Reflecting Layer)

The coating solution Ch-C for a light reflecting layer was prepared in the same manner as that for the coating solution Ch-A for a light reflecting layer except that the content of the chiral agent A was set to 4.50 parts by mass.

Mixture of rod-like liquid crystal compounds

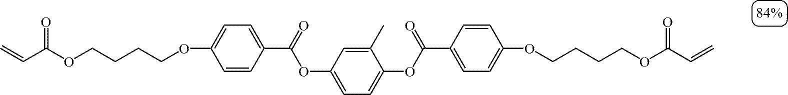

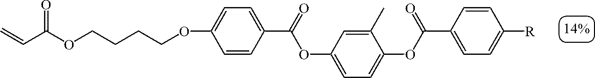

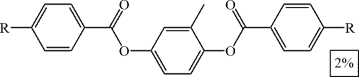

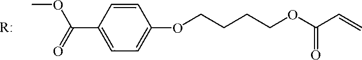

In the mixture shown above, each numerical value denotes the content in units of % by mass. In addition, R represents a group bonded via an oxygen atom. Further, the average molar absorption coefficient of the rod-like liquid crystal compound at a wavelength of 300 to 400 nm was 140/mol·cm.

Chiral agent A

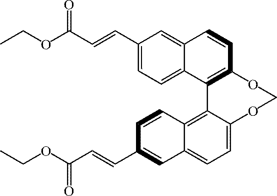

Surfactant F1

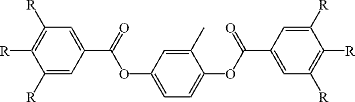

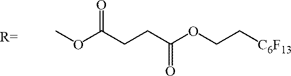

Surfactant F2

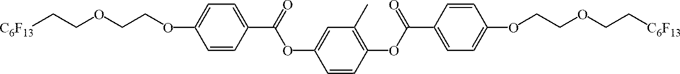

Photopolymerization initiator B

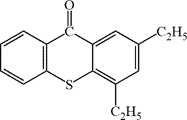 [SMILES: CCc1cc(CC)c2sc3ccccc3c(=O)c2c1]

The chiral agent A is a chiral agent in which the helical twisting power (HTP) is reduced by light.

A surface of the PET film (temporary support) that was not provided with an easy-adhesion layer was subjected to a rubbing treatment, coated with the coating solution Ch-A for a light reflecting layer prepared above using a #8 wire bar coater, and dried at 110° C. for 120 seconds.

Subsequently, the surface was irradiated with light using a metal halide lamp at 100°, an illuminance of 80 mW, and an irradiation dose of 500 mJ/cm² in a low oxygen atmosphere (100 ppm or less), thereby forming a red light reflecting layer consisting of a cholesteric liquid crystal layer. The irradiation with light was performed from the side of the cholesteric liquid crystal layer.

A green light reflecting layer consisting of a cholesteric liquid crystal layer was prepared on the PET film (temporary support) by the same procedure as that for the red light reflecting layer except that the coating solution was changed to Ch-B.

A blue light reflecting layer consisting of a cholesteric liquid crystal layer was prepared on the PET film (temporary support) by the same procedure as that for the red light reflecting layer except that the coating solution was changed to Ch-C.

As a result of observation performed on cross sections of the red light reflecting layer, the green light reflecting layer, and the blue light reflecting layer prepared above using a SEM, stripe patterns of bright portions and dark portions were observed in all cases. Here, the intervals between the bright portions and the dark portions in the stripe pattern of the cholesteric liquid crystal layer did not change in the layer.

In addition, the thicknesses of the cholesteric liquid crystal layers of the red light reflecting layer, the green light reflecting layer, and the blue light reflecting layer were respectively 4 µm.

Further, each of the red light reflecting layer, the green light reflecting layer, and the blue light reflecting layer in the reflective circular polarizer 1 is a cholesteric liquid crystal layer consisting of a rod-like liquid crystal compound.

In addition, the surface roughnesses Ra of the red light reflecting layer, the green light reflecting layer, and the blue light reflecting layer on the temporary support side were respectively 20 nm or less.

Further, the surface roughness Ra (arithmetic average roughness Ra) was measured by, for example, a non-contact surface/layer cross-sectional shape measuring system VertScan (manufactured by Ryoka System, Inc.). Specifically, a surface of the film to be measured on a side opposite to the measurement surface was bonded to a smooth glass base material with a pressure sensitive adhesive having a thickness of 5 um, and the surface unevenness was measured. The surface roughness Ra was calculated from unevenness data in a range of approximately 4 mm square. Here, Eagle XG (manufactured by Corning Inc, thickness of 0.7 µm) was used as the glass base material, and NCF-D692 (manufactured by Lintec Corporation, thickness of 5 µm) was used as the pressure sensitive adhesive. In this regard, the same applies to the following measurement of the surface roughness Ra.

### Preparation of Reflective Circular Polarizer 2

### (Coating Solution Ch-D for Light Reflecting Layer)

The composition shown below was stirred and dissolved in a container maintained at 50° C., thereby preparing a coating solution Ch-D for a light reflecting layer.

Coating solution Ch-D for light reflecting layer
Disk-like liquid crystal compound (A) shown below: 80 parts by mass
Disk-like liquid crystal compound (B) shown below: 20 parts by mass
Polymerizable monomer E1: 10 parts by mass
Surfactant F4: 0.3 parts by mass
Photopolymerization initiator (IRGACURE 907, manufactured by BASF SE): 3 parts by mass
Chiral agent A: 4.30 parts by mass
Methyl ethyl ketone: 290 parts by mass
Cyclohexanone: 50 parts by mass

Disk-like liquid crystal compound (A)

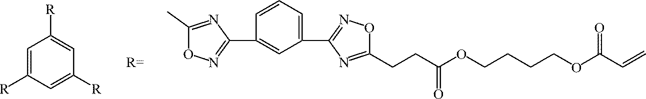

Disk-like liquid crystal compound (B)

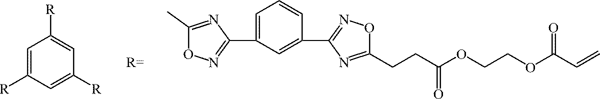

Polymerizable monomer E1

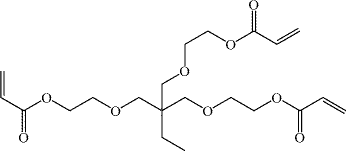 [SMILES: C=CC(=O)OCCOCC(CC)(COCCOC(=O)C=C)COCCOC(=O)C=C]

Surfactant F4

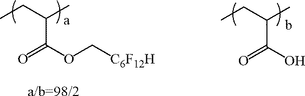

A surface of the PET film (temporary support) that was not provided with an easy-adhesion layer was subjected to a rubbing treatment, coated with the coating solution Ch-C for a light reflecting layer prepared above using a wire bar coater, and dried at 110° C. for 120 seconds. Subsequently, the surface was irradiated with light using a metal halide lamp at 100°, an illuminance of 80 mW, and an irradiation dose of 500 mJ/cm² in a low oxygen atmosphere (100 ppm or less), thereby forming a blue light reflecting layer consisting of a cholesteric liquid crystal layer. The irradiation with light was performed from the side of the cholesteric liquid crystal layer.

Next, the blue light reflecting layer was coated with the coating solution Ch-A for a light reflecting layer using a wire bar coater and dried at 110° C. for 120 seconds. Subsequently, the surface was irradiated with light using a metal halide lamp at 100°, an illuminance of 80 mW, and an irradiation dose of 500 mJ/cm² in a low oxygen atmosphere (100 ppm or less), thereby forming a red light reflecting layer consisting of a cholesteric liquid crystal layer on the blue light reflecting layer. The irradiation with light was performed from the side of the cholesteric liquid crystal layer.

Next, the surface of the red light reflecting layer was subjected to corona treatment at a discharge amount of 150 W·min/m², and the surface subjected to the corona treatment was coated with the coating solution Ch-D for a light reflecting layer using a wire bar.

Subsequently, the coating film was dried at 70° C. for 2 minutes and heat-aged at 115° C. for 3 minutes after the solvent was vaporized, thereby obtaining a uniform alignment state. Thereafter, the coating film was maintained at 45° C. and irradiated with ultraviolet rays (300 mJ/cm²) using a high-pressure mercury lamp in a nitrogen atmosphere, thereby preparing a green light reflecting layer consisting of a cholesteric liquid crystal layer on the red light reflecting layer.

As a result of observation performed on a cross-section of the prepared laminated film using a SEM, stripe patterns of bright portions and dark portions were observed. Here, a layer having a constant stripe pattern interval corresponding to the blue light reflecting layer was observed to have a thickness of 2.9 µm, a layer having a constant stripe pattern interval corresponding to the red light reflecting layer was observed to have a thickness of 3.9 µm, and a layer having a constant stripe pattern interval corresponding to the green light reflecting layer was observed to have a thickness of 4.8 µm from the PET film (temporary support) side.

In the reflective circular polarizer 2, both the red light reflecting layer and the blue light reflecting layer are cholesteric liquid crystal layers consisting of a rod-like liquid crystal compound, and the green light reflecting layer is a cholesteric liquid crystal layer consisting of a disk-like liquid crystal compound.

In addition, the surface roughness Ra of the prepared laminated film on the temporary support side was 20 nm or less.

### Preparation of Positive C-Plate 1

A positive C-plate 1 was prepared by adjusting the film thickness with reference to the method described in paragraphs 0132 to 0134 of JP2016-053709A. Here, the support was changed from a polyethylene terephthalate film (PET film) to a triacetyl cellulose film (TAC film).

The surface roughness Ra of the TAC film on the liquid crystal layer side was 22 nm.

The positive C-plate 1 had an in-plane retardation Re of 0.2 nm and a retardation Rth of -310 nm in the thickness direction.

### Preparation of Retardation Layer 1

A retardation layer 1 having reverse dispersibility was prepared on a cellulose acylate film serving as a temporary support with reference to the method described in paragraphs 0151 to 0163 of JP2020-084070A.

The retardation layer 1 had an in-plane retardation Re of 146 nm and a retardation Rth of 73 nm in the thickness direction.

### Preparation of Positive C-Plate 2

A positive C-plate 2 was prepared in the same manner as in the positive C-plate 1 except that the film thickness was adjusted. Further, a TAC film was used as the support in the preparation of the positive C-plate 1, but a PET film was used as the temporary support in the preparation of the positive C-plate 2.

The positive C-plate 2 had an in-plane retardation Re of 0.1 nm and a retardation Rth of -70 nm in the thickness direction.

### Preparation of Linear Polarizer 1

### <Preparation of Cellulose Acylate Film 1>

### (Preparation of Core Layer Cellulose Acylate Dope)

The following composition was put into a mixing tank and stirred to dissolve each component, thereby preparing a cellulose acetate solution used as a core layer cellulose acylate dope.

Core layer cellulose acylate dope
Cellulose acetate having acetyl substitution degree of 2.88: 100 parts by mass
Polyester compound B described in example of JP2015-227955A: 12 parts by mass
Compound F shown below: 2 parts by mass
Methylene chloride (first solvent): 430 parts by mass
Methanol (second solvent): 64 parts by mass

Compound F

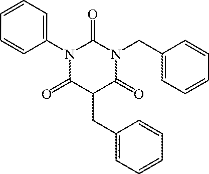 [SMILES: O=C1C(Cc2ccccc2)C(=O)N(c2ccccc2)C(=O)N1Cc1ccccc1]

### (Preparation of Outer Layer Cellulose Acylate Dope)

10 parts by mass of the following matting agent solution was added to 90 parts by mass of the above-described core layer cellulose acylate dope, thereby preparing a cellulose acetate solution used as an outer layer cellulose acylate dope.

Matting agent solution
Silica particles with average particle size of 20 nm (AEROSIL R972, manufactured by Nippon Aerosil Co., Ltd.): 2 parts by mass
Methylene chloride (first solvent): 76 parts by mass
Methanol (second solvent) 11 parts by mass
Core layer cellulose acylate dope described above: 1 parts by mass

### (Preparation of Cellulose Acylate Film 1)

The core layer cellulose acylate dope and the outer layer cellulose acylate dope were filtered through filter paper having an average pore size of 34 µm and a sintered metal filter having an average pore size of 10 µm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 µm, and the optical film was used as a cellulose acylate film 1. The in-plane retardation of the obtained cellulose acylate film 1 was 0 nm.

### <Preparation of Photo-Alignment Film 1>

The cellulose acylate film 1 (temporary support) was continuously coated with the following coating solution PA1 for forming an alignment layer using a wire bar. The support on which a coating film was formed was dried with hot air at 140° C. for 120 seconds, and the coating film was irradiated with polarized ultraviolet rays (10 mJ/cm², using an ultra-high pressure mercury lamp) to form a photo-alignment layer PA1, thereby obtaining a photo-alignment film 1.

The film thickness was 0.3 µm.

(Coating solution PA1 for forming alignment layer)
Polymer PA-1 shown below: 100.00 parts by mass
Acid generator PAG-1 shown below: 5.00 parts by mass
Acid generator CPI-110TF shown below: 0.005 parts by mass
Xylene: 1220.00 parts by mass
Methyl isobutyl ketone: 122.00 parts by mass

Polymer PA-1

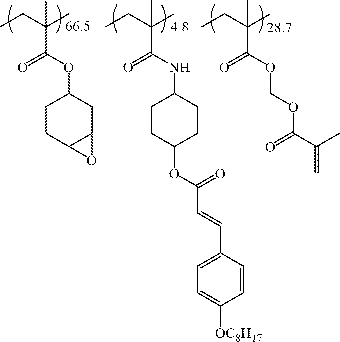

Acid generator PAG-1

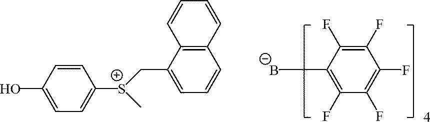

Acid generator CPI-110F

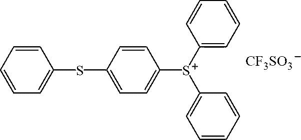

### <Formation of Light Absorption Anisotropic Layer P1>

The obtained alignment layer PA1 was continuously coated with the following composition P1 for forming a light absorption anisotropic layer using a wire bar to form a coating layer P1.

Next, the coating layer P1 was heated at 140° C. for 30 seconds, and the coating layer P1 was cooled to room temperature (23° C.).

Next, the coating layer was heated at 90° C. for 60 seconds and cooled to room temperature again.

Thereafter, the coating layer was irradiated with an LED lamp (center wavelength of 365 nm) for 2 seconds under an irradiation condition of an illuminance of 200 mW/cm² to form a light absorption anisotropic layer P1 on the alignment layer PA1, thereby preparing a linear polarizer 1.

The film thickness of the light absorption anisotropic layer P1 was 1.6 µm.

Composition of composition P1 for forming light absorption anisotropic layer
Dichroic substance D-1 shown below: 0.25 parts by mass
Dichroic substance D-2 shown below: 0.36 parts by mass
Dichroic substance D-3 shown below: 0.59 parts by mass
Polymer liquid crystal compound P-1 shown below: 2.21 parts by mass
Low-molecular-weight liquid crystal compound M-1 shown below: 1.36 parts by mass
Polymerization initiator IRGACURE OXE-02 (manufactured by BASF SE): 0.200 parts by mass
Surfactant F-1 shown below: 0.026 parts by mass
Cyclopentanone: 46.00 parts by mass
Tetrahydrofuran: 46.00 parts by mass
Benzyl alcohol: 3.00 parts by mass

Dichroic substance D-1

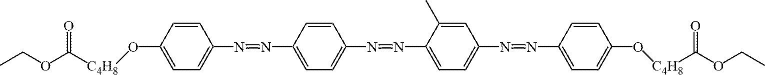

Dichroic substance D-2

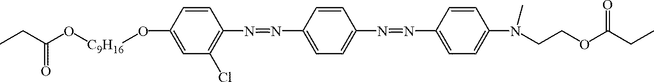

Dichroic substance D-3

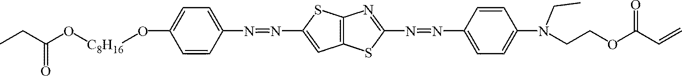

Polymer liquid crystal compound P-1

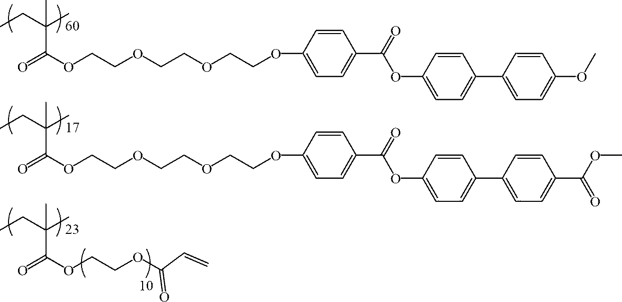

Low-molecular-weight liquid crystal compound M-1

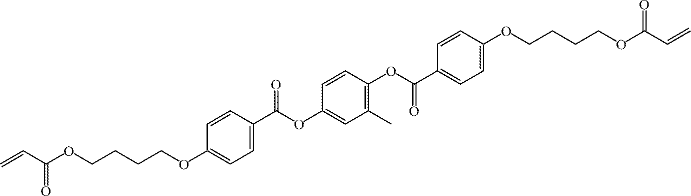 [SMILES: C=CC(=O)OCCCCOc1ccc(C(=O)Oc2ccc(OC(=O)c3ccc(OCCCCOC(=O)C=C)cc3)c(C)c2)cc1]

Surfactant F-1

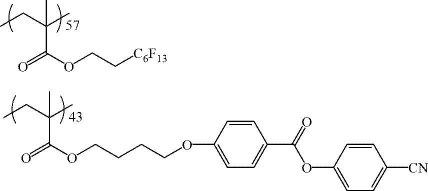

### [Preparation of Linear Polarizer 2]

A linear polarizer 2 including a PVA layer with a thickness of 4 µm was formed on a PET film serving as a temporary support with reference to the method of preparing a thin polarizing film provided with a resin base material described in examples of JP2015-129826A.

### [Preparation of Retardation Layer 2]

A retardation layer 2 consisting of a polycarbonate-based resin and having reverse dispersibility with respect to a wavelength was prepared with reference to the method described in paragraphs 0108 to 0109 of JP2020-76968A.

Further, the Re of the retardation layer 2 was 140 nm.

### Example 1

Each light reflecting layer prepared in the reflective circular polarizer 1 was transferred to the support (TAC) of the prepared positive C-plate 1 such that the blue light reflecting layer, the green light reflecting layer, and the red light reflecting layer were laminated in this order from the support side.

Further, the transfer of each light reflecting layer was carried out by the following procedures.

The layer to laminate was bonded to the temporary support consisting of a glass base material, and the temporary support (PET film) used for forming the light reflecting layer was peeled off.

A SiOx layer having a thickness of 50 nm was vapor-deposited on both the surface of the layer to laminate and the surface of the layer to be laminated. The vapor deposition was carried out by, for example, a vapor deposition device (model number ULEYES) using SiOx powder as a vapor deposition source. Thereafter, the surface of the formed SiOx layer was subjected to a plasma treatment.

The formed SiOx layers were bonded to each other at 120° C., and the temporary support (glass base material) was peeled off.

Next, the positive C-plate 2 was laminated on the red light reflecting layer by the same procedures (1) to (3) as described above.

Next, the retardation layer 1 was laminated on the positive C-plate 2 by the same procedures (1) to (3) as described above.

Finally, the linear polarizer 1 (light absorption anisotropic layer P1) was laminated on the retardation layer 1 by the same procedures (1) to (3) as described above. Here, the lamination was made such that the slow axis of the retardation layer 1 and the absorption axis of the light absorption anisotropic layer P1 formed an angle of 45° and the polarization axis of light emitted from the retardation layer 1 and the transmission axis of the light absorption anisotropic layer P1 were parallel to each other.

In this manner, a laminated optical film of Example 1 was prepared.

In the laminated optical film of Example 1, the surface roughness Ra of the positive C-plate serving as an image incident surface was measured. As described above, the image incident surface is a surface of the reflective circular polarizer on a side opposite to the linear polarizer in the laminated optical film. As a result, the surface roughness Ra of the image incident surface, that is, the positive C-plate was 30 nm.

As described above, the surface roughness Ra of the TAC film serving as a support on the liquid crystal layer side was 22 nm.

### Example 2

The green light reflecting layer of the prepared reflective circular polarizer 2 was bonded to a temporary support consisting of a glass base material, and the temporary support (PET film) used for forming the reflective circular polarizer 2 was peeled off to expose the blue light reflecting layer.

The positive C-plate 2 was laminated on the blue light reflecting layer by the same procedures (1) to (3) as in Example 1.

Next, the retardation layer 1 was laminated on the positive C-plate 2 by the same procedures (1) to (3) as in Example 1.

Further, the linear polarizer 1 (light absorption anisotropic layer P1) was laminated on the retardation layer 1 by the same procedures (1) to (3) as in Example 1. Here, the lamination was made such that the slow axis of the retardation layer 1 and the absorption axis of the light absorption anisotropic layer P1 formed an angle of 45° and the polarization axis of light emitted from the retardation layer 1 and the transmission axis of the light absorption anisotropic layer P1 were parallel to each other.

In addition, “MASTACK, AS3-304” (manufactured by Fujimori Kogyo Co., Ltd.) was prepared. This is an antireflection film formed by providing an antireflection layer consisting of a moth-eye layer on a support made of TAC. The surface roughness Ra of the TAC support of the antireflection film on the moth-eye layer side was 25 nm.

The temporary support consisting of a glass base material bonded to the reflective circular polarizer 2 was peeled off, and the TAC support of the antireflection film and the green light reflecting layer exposed by the peeling of the glass base material were laminated by the same procedures (2) and (3) as in Example 1, thereby preparing a laminated optical film of Example 2.

In the laminated optical film of Example 2, the surface roughness Ra of the moth-eye layer serving as the image incident surface was measured. As a result, the surface roughness Ra of the image incident surface was 30 nm.

### Example 3

A laminated optical film of Example 3 was prepared in the same manner as in Example 1 except that the linear polarizer 1 (light absorption anisotropic layer P1) was changed to the linear polarizer P2.

In the laminated optical film of Example 3, the surface roughness Ra of the positive C-plate serving as the image incident surface was measured. As a result, the surface roughness Ra of the image incident surface was 60 nm.

### Example 4

A laminated optical film of Example 4 was prepared in the same manner as in Example 1 except that the retardation layer 1 was changed to the retardation layer 2.

In the laminated optical film of Example 4, the surface roughness Ra of the positive C-plate serving as the image incident surface was measured. As a result, the surface roughness Ra of the image incident surface was 35 nm.

### Example 5

The laminated optical film of Example 5 was prepared in the same manner as in Example 1 except that the linear polarizer 1 (light absorption anisotropic layer P1) was changed to the linear polarizer P2 and the retardation layer 1 was changed to the retardation layer 2.

In the laminated optical film of Example 4, the surface roughness Ra of the positive C-plate serving as the image incident surface was measured. As a result, the surface roughness Ra of the image incident surface was 65 nm.

### Example 6

A laminated optical film of Example 6 was prepared in the same manner as in Example 2 except that the retardation layer 1 was laminated on the blue light reflecting layer without laminating the positive C-plate 2 and the linear polarizer 1 was laminated thereon.

In the laminated optical film of Example 6, the surface roughness Ra of the moth-eye layer serving as the image incident surface was measured. As a result, the surface roughness Ra of the image incident surface was 30 nm.

### Example 7

An antireflection film obtained by providing an antireflection layer consisting of a moth-eye layer was prepared on a support (thickness of 75 µm) made of polymethyl methacrylate (PMMA). Further, the moth-eye layer was the same as in Example 2.

In this antireflection film, the surface roughness Ra of the PMMA support on the moth-eye layer side was 20 nm.

The green light reflecting layer of the prepared reflective circular polarizer 2 and the support (PMMA) of the antireflection film were laminated by the same procedures (2) and (3) as in Example 1.

Next, the temporary support (PET film) of the reflective circular polarizer 2 was peeled off, and the positive C-plate 2 was laminated on the exposed blue light reflecting layer by the same procedures (1) to (3) as in Example 1.

Next, the retardation layer 1 was laminated on the positive C-plate 2 by the same procedures (1) to (3) as in Example 1.

Finally, the linear polarizer 1 (light absorption anisotropic layer P1) was laminated on the retardation layer 1 by the same procedures (1) to (3) as in Example 1. Here, the lamination was made such that the slow axis of the retardation layer 1 and the absorption axis of the light absorption anisotropic layer P1 formed an angle of 45° and the polarization axis of light emitted from the retardation layer 1 and the transmission axis of the light absorption anisotropic layer P1 were parallel to each other.

In this manner, a laminated optical film of Example 7 was prepared.

In the laminated optical film of Example 7, the surface roughness Ra of the moth-eye layer serving as the image incident surface was measured. As a result, the surface roughness Ra of the image incident surface was 30 nm.

### Example 8

An antireflection film was prepared in the same manner as in Example 7 except that a support (thickness of 100 µm) made of a cyclic olefin resin (COP) was used in place of the support made of polymethyl methacrylate.

A laminated optical film of Example 8 was prepared in the same manner as in Example 7 except that this antireflection film was used.

The surface roughness Ra of the COP support of the antireflection film on the moth-eye layer side was 20 nm.

In the laminated optical film of Example 8, the surface roughness Ra of the moth-eye layer serving as the image incident surface was measured. As a result, the surface roughness Ra of the image incident surface was 30 nm.

### Example 9

A laminated optical film of Example 9 was prepared in the same manner as in Example 7 except that the retardation layer 1 was laminated on the blue light reflecting layer without laminating the positive C-plate 2 and the linear polarizer 1 was laminated thereon.

In the laminated optical film of Example 9, the surface roughness Ra of the moth-eye layer serving as the image incident surface was measured. As a result, the surface roughness Ra of the image incident surface was 30 nm.

### Example 10

A laminated optical film of Example 10 was prepared by further laminating the second retardation layer 1 on the linear polarizer of the laminated optical film of Example 7 by the same procedures (1) to (3) as in Example 1.

Further, the second retardation layer was laminated such that the slow axis thereof was oriented in the same direction as that of the slow axis of the first retardation layer.

In the laminated optical film of Example 10, the surface roughness Ra of the moth-eye layer serving as the image incident surface was measured. As a result, the surface roughness Ra of the image incident surface was 30 nm.

### Comparative Example 1

A tablet computer iPad (registered trademark, manufactured by Apple Inc.) was disassembled, and the polarizing plate was peeled off from the backlight-side surface of the liquid crystal cell. In the polarizing plate that had been peeled off, a reflective linear polarizer and a linear polarizer were laminated from the incident side. The reflective linear polarizer was a film (APF) obtained by stretching a dielectric multilayer film, and the linear polarizer had a stretched polyvinyl alcohol (PVA) film stained with iodine.

The above-described retardation layer 1 was bonded to the surface of the reflective linear polarizer of the peeled polarizing plate with a pressure sensitive adhesive such that the slow axis of the retardation layer 1 and the reflection axis of the reflective linear polarizer formed an angle of 45°, and transferred.

In this manner, a laminated optical film of Comparative Example 1 having a function as a reflective circular polarizer was prepared.

In the laminated optical film of Comparative Example 1, the retardation layer 1 (¼ λ layer (coating)) corresponds to the image incident surface. The surface roughness Ra of the image incident surface was 160 nm.

### Comparative Example 2

A laminated optical film of Comparative Example 2 was prepared in the same manner as in Example 1 except that the support (TAC) of the positive C-plate 1 was changed to a TAC film having a surface roughness Ra of 65 nm on the liquid crystal layer side in Example 1.

In the laminated optical film of Comparative Example 2, the surface roughness Ra of the positive C-plate serving as the image incident surface was measured. As a result, the surface roughness Ra of the image incident surface was 120 nm.

### <Evaluation of Polarization Degree>

The polarization degrees of the transmitted light and the reflected light of the obtained laminated optical films were measured by the following method.

A circularly polarizing plate consisting of a ¼ wavelength plate and a linear polarizer was bonded to a light receiving portion of “Goniophotometer” (manufactured by Murakami Color Research Laboratory). The laminated optical film was disposed on the stage, and non-polarized light having a wavelength of 550 nm was incident on the reflecting surface. Next, the light receiving portion was allowed to rotate to measure the light quantity of the transmitted light and the reflected light from the laminated optical film, the light quantity was divided by the light quantity of the incidence ray, and the transmittance and the reflectivity with respect to the dextrorotatory circularly polarized light were calculated. In addition, the circularly polarizing plate bonded to the light receiving portion was replaced, and the same measurement as described above was performed, and the transmittance and the reflectivity with respect to the levorotatory circularly polarized light were calculated.

Here, the transmittance of the dextrorotatory circularly polarized light was defined as Tr and the transmittance of the levorotatory circularly polarized light was defined as T1, and a polarization degree Pct of the transmitted light was calculated according to Equation (2).

$$\text{Pct} \text{=} \left|\left(\text{Tr - Tl}\right) / \left(\text{Tr} \text{+} \text{Tl}\right)\right| \qquad \text{Equation (2):}$$

Here, the reflectivity of the dextrorotatory circularly polarized light was defined as Rr and the reflectivity of the levorotatory circularly polarized light was defined as Rl, and a polarization degree Pcr of the reflected light was calculated according to Equation (3).

$$\text{Pcr} \text{=} \left|\left(\text{Rr - Rl}\right) / \left(\text{Rr} \text{+} \text{Rl}\right)\right| \qquad \text{Equation (3):}$$

The results are listed in the table below.

### <Evaluation of Polarization Degree After Molding>

The polarization degree after molding was also measured for the laminated optical films of Examples 6 to 10 and Comparative Example 1.

That is, the laminated optical film to be measured was cut into a size of 200 mm × 300 mm, and vacuum molding was performed by the method described in JP2012-116094A using a convex lens having a diameter of 50 mm and a thickness of 10 mm as a mold. The molding temperature was set to 110° C.

The polarization degree was measured with respect to the molded laminated optical film by the same method as described above.

The results are shown in Table 1 below.

### <Evaluation of Image Sharpness and Ghost>

The lens of the virtual reality display device “Huawei VR Glass” (manufactured by Huawei Technologies Co., Ltd.), which is a virtual reality display device for which a reciprocating optical system is employed, was disassembled, and the lens on the most viewing side was taken out. This lens is a plano-convex lens having a convex surface on the viewing side, and a reflective circular polarizer is bonded to the plane side.

Next, the reflective circular polarizer was peeled off from the lens, and instead of the reflective circular polarizer, the laminated optical films of Examples 1 to 10 and Comparative Examples 1 and 2 were bonded such that the linear polarizer side was the viewing side.

The above-described lens was incorporated into the main body again to prepare a virtual reality display device.

In the prepared virtual reality display device, a black-and-white checkered pattern was displayed on an image display panel, and image sharpness and ghosts were visually evaluated.

In regard to the image sharpness, a case where the black-and-white checkered pattern was visually recognizable extremely clearly over the entire region of the lens was evaluated as A, a case where the black-and-white checkered pattern was visually recognizable clearly over the entire region of the lens was evaluated as B, and a case where the black-and-white checkered pattern was unclear was evaluated as C.

Further, in regard to the ghosts, a case where ghosts were not visually recognizable over the entire region of the lens was evaluated as A, a case where ghosts were slightly visually recognized over the entire region of the lens at an acceptable level in practical use was evaluated as B, and a case where ghosts were visually recognized at a problematic level in practical use was evaluated as C.

The results are listed in the table below.

Further, the layer configurations of the laminated optical films are collectively listed in the following table.

Further, in the layer configurations listed in the following table, the positive C-layer denotes a positive C-plate, the support (TAC) denotes a support made of triacetyl cellulose, the support (PMMA) denotes a support made of polymethyl methacrylate, and the support (COP) denotes a support made of a cyclic olefin resin, the term rod-like denotes that the liquid crystal compound forming a reflective layer (cholesteric liquid crystal layer) is a rod-like liquid crystal compound, and the term disk-like denotes that the liquid crystal compound forming a reflective layer (cholesteric liquid crystal layer) is a disk-like liquid crystal compound, the ¼λ layer (coating) denotes the retardation layer 1, that is, a ¼λ layer formed by a coating method, and the ¼λ layer (PC) denotes the retardation layer 2, that is, a ¼λ layer consisting of a polycarbonate resin, and the linear polarizer layer (coating) denotes the linear polarizer layer 1 (light absorption anisotropic layer P1), that is, a linear polarizer formed by a coating method, and the linear polarizer layer (PVA) denotes the linear polarizer 2, that is, a linear polarizer including a PVA layer.

TABLE 1

| | Example 1 | Example 2 | Example 3 | Example 4 | Example 5 | Example 6 |
|---|---|---|---|---|---|---|
| Layer configuration | Linear polarizer layer (coating) | Linear polarizer layer (coating) | Linear polarizer layer (stretching) | Linear polarizer layer (coating) | Linear polarizer layer (stretching) | |
| | ¼λ layer (coating) | ¼λ layer (coating) | ¼λ layer (coating) | ¼λ layer (stretching) | ¼λ layer (stretching) | Linear polarizer layer (coating) |
| | Positive C-layer | Positive C-layer | Positive C-layer | Positive C-layer | Positive C-layer | ¼λ layer (coating) |
| | Red light reflecting laver (rod-like) | Blue light reflecting laver (rod-like) | Red light reflecting laver (rod-like) | Red light reflecting laver (rod-like) | Red light reflecting laver (rod-like) | Blue light reflecting laver (rod-like) |
| | Green light reflecting layer (rod-like) | Red light reflecting layer (rod-like) | Green light reflecting layer (rod-like) | Green light reflecting layer (rod-like) | Green light reflecting layer (rod-like) | Red light reflecting layer (rod-like) |
| | Blue light reflecting layer (rod-like) | Green light reflecting layer (disk-like) | Blue light reflecting layer (rod-like) | Blue light reflecting layer (rod-like) | Blue light reflecting layer (rod-like) | Green light reflecting layer (disk-like) |
| | Support (TAC) | Support (TAC) | Support (TAC) | Support (TAC) | Support (TAC) | Support (TAC) |
| | Positive C-layer | Moth-eye layer | Positive C-layer | Positive C-layer | Positive C-layer | Moth-eye layer |
| Surface roughness Ra of support | 22 nm | 25 nm | 22 nm | 22 nm | 22 nm | 25 nm |
| Surface roughness Ra of image incident surface | 30 nm | 30 nm | 60 nm | 35 nm | 65 nm | 30 nm |
| Polarization degree of transmitted light | 0.99 | 0.99 | 0.99 | 0.99 | 0.99 | 0.99 |
| Polarization degree of reflected light | 0.97 | 0.97 | 0.97 | 0.96 | 0.96 | 0.97 |
| Polarization degree of transmitted light after molding | - | - | - | - | - | 0.88 |
| Polarization degree of reflected light after molding | - | - | - | - | - | 0.91 |
| Image sharpness | A | A | A | A | A | A |
| Ghost | A | A | A | A | A | B |
| | Example 7 | Example 8 | Example 9 | Example 10 | Comparative Example 1 | Comparative Example 2 |
| Layer configuration | | | | ¼λ layer (coating) | | |
| | Linear polarizer layer (coating) | Linear polarizer layer (coating) | | Linear polarizer layer (coating) | Linear polarizer layer (stretching) | Linear polarizer layer (coating) |
| | ¼λ layer (coating) | ¼λ layer (coating) | Linear polarizer layer (coating) | ¼λ layer (coating) | Reflective linear polarizer (APF) | ¼λ layer (coating) |
| | Positive C-layer | Positive C-layer | ¼λ layer (coating) | Positive C-layer | ¼λ layer (coating) | Positive C-layer |
| | Blue light reflecting laver (rod-like) | Blue light reflecting laver (rod-like) | Blue light reflecting laver (rod-like) | Blue light reflecting laver (rod-like) | | Red light reflecting laver (rod-like) |
| | Red light reflecting layer (rod-like) | Red light reflecting layer (rod-like) | Red light reflecting layer (rod-like) | Red light reflecting layer (rod-like) | | Green light reflecting layer (rod-like) |
| | Green light reflecting layer (disk-like) | Green light reflecting layer (disk-like) | Green light reflecting layer (disk-like) | Green light reflecting layer (disk-like) | | Blue light reflecting layer (rod-like) |
| | Support (PMMA) | Support (COP) | Support (PMMA) | Support (PMMA) | | Support (TAC) |
| | Moth-eye layer | Moth-eye layer | Moth-eye layer | Moth-eye layer | | Positive C-laver |
| Surface roughness Ra of support | 20 nm | 20 nm | 20 nm | 20 nm | - | 65 nm |
| Surface roughness Ra of image incident surface | 30 nm | 30 nm | 30 nm | 30 nm | 160 nm | 120 nm |
| Polarization degree of transmitted light | 0.99 | 0.99 | 0.99 | 0.99 | 0.99 | 0.99 |
| Polarization degree of reflected light | 0.97 | 0.97 | 0.97 | 0.98 | 0.95 | 0.97 |
| Polarization degree of transmitted light after molding | 0.99 | 0.99 | 0.99 | 0.98 | 0.89 | - |
| Polarization degree of reflected light after molding | 0.97 | 0.97 | 0.97 | 0.98 | 0.87 | - |
| Image sharpness | A | A | A | A | C | C |
| Ghost | A | A | B | A | C | A |

In the table above, since the reflective linear polarizer (APF) itself acted as a support in Comparative Example 1, the surface roughness Ra of the support was not measured.

As listed in the table above, all the laminated optical films of the present invention in which the surface roughness Ra of the image incident surface was 100 nm or less had extremely high image sharpness in the black-and-white checkered pattern over the entire region of the lens. On the contrary, in the laminated optical films of the comparative examples in which the surface roughness Ra of the image incident surface was greater than 100 nm, the black-and-white checkered pattern was unclear and the image sharpness was low. In addition, as described in Comparative Example 1, the surface roughness Ra of the image incident surface increases as the surface roughness Ra of the support increases.

As described in Examples 2 and 6, and Examples 7 and 9, in the laminated optical films of the present invention, the polarization degrees of the reflected light and the transmitted light were increased by using the positive C-plate as necessary, and as a result, it was possible to display an image with an extremely small amount of ghosts.

As described in Examples 1, 2, 7, 8, and the like, in the laminated optical films of the present invention, since the reflective circular polarizer had the light reflecting layer consisting of a rod-like liquid crystal compound and the light reflecting layer consisting of a disk-like liquid crystal compound, it was possible to obtain a higher polarization degree than that of the reflective circular polarizer in which all light reflecting layers consisted of a rod-like liquid crystal compound even in a case where the number of positive C-plates was reduced.

As described in Example 10, since the second retardation layer was provided on the surface of the linear polarizer, it was possible to improve the polarization degree of the reflected light by preventing reflection on the surface on the observation side.

Further, as described in Examples 6 to 10, in the laminated optical films of the present invention, the molding was made even at a low temperature by using a resin base material having a tan δ peak temperature of 170° C. or lower as the support, and as a result, it was possible to prevent a decrease in the polarization degree of the reflected light and the transmitted light after the molding even in a case where the molding was carried out according to, for example, the lens shape.

As shown in the results described above, the effects of the present invention are apparent.

### EXPLANATION OF REFERENCES

100: laminated optical film
101: antireflection layer
102: positive C-plate
103: reflective circular polarizer
104: positive C-plate
105: retardation layer
106: linear polarizer
300: half mirror
400: circular polarizer
500: image display panel
1000: ray forming virtual image
2000: ray forming ghost

What is claimed is:

1. A laminated optical film comprising, in the following order, at least:
a reflective circular polarizer;
a retardation layer that converts circularly polarized light into linearly polarized light; and
a linear polarizer,
wherein a surface of the reflective circular polarizer on a side opposite to the linear polarizer has a surface roughness Ra of 100 nm or less.

2. The laminated optical film according to claim 1, further comprising:
a support having a surface roughness Ra of 50 nm or less.

3. The laminated optical film according to claim 2,
wherein the support is a resin base material having a tan δ peak temperature of 170° C. or lower.

4. The laminated optical film according to claim 1,
wherein the laminated optical film does not have a support.

5. The laminated optical film according to claim 1,
wherein the reflective circular polarizer includes at least a light reflecting layer formed by immobilizing a cholesteric liquid crystalline phase.

6. The laminated optical film according to claim 1, wherein the reflective circular polarizer includes at least a blue light reflecting layer with a reflectivity of 40% or greater for light having a wavelength of 450 nm, a green light reflecting layer with a reflectivity of 40% or greater for light having a wavelength of 530 nm, and a red light reflecting layer with a reflectivity of 40% or greater for light having a wavelength of 630 nm.

7. The laminated optical film according to claim 6,
wherein the reflective circular polarizer further includes an infrared light reflecting layer with a reflectivity of 40% or greater for light having a wavelength of 800 nm.

8. The laminated optical film according to claim 1,
wherein the reflective circular polarizer includes at least a light reflecting layer formed by immobilizing a cholesteric liquid crystalline phase containing a rod-like liquid crystal compound and a light reflecting layer formed by immobilizing a cholesteric liquid crystalline phase containing a disk-like liquid crystal compound.

9. The laminated optical film according to claim 1,
wherein the retardation layer has substantially reverse dispersibility with respect to a wavelength.

10. The laminated optical film according to claim 1,
wherein the retardation layer includes at least a layer formed by immobilizing a uniformly aligned liquid crystal compound.

11. The laminated optical film according to claim 1,
wherein the retardation layer includes at least a layer formed by immobilizing a twistedly aligned liquid crystal compound with a helical axis in a thickness direction.

12. The laminated optical film according to claim 1,
wherein the linear polarizer consists of a layer having a thickness of 10 µm or less.

13. The laminated optical film according to claim 1,
wherein the linear polarizer includes at least a light absorption anisotropic layer containing a liquid crystal compound and a dichroic substance.

14. The laminated optical film according to claim 1, further comprising:
a positive C-plate.

15. The laminated optical film according to claim 1, further comprising:
one or more functional layers or a support,
wherein the laminated optical film includes, in the following order, at least: at least either the one or more functional layers or the support; the reflective circular polarizer; the retardation layer that converts circularly polarized light into linearly polarized light; and the linear polarizer.

16. The laminated optical film according to claim 1, further comprising:
an antireflection layer on any surface.

17. The laminated optical film according to claim 16,
wherein the antireflection layer is a moth-eye film or an AR film.

18. An image display device comprising:
the laminated optical film according to claim 1; and
an image display element.

19. The image display device according to claim 18,
wherein the image display device is a virtual reality display device.

20. The laminated optical film according to claim 2,
wherein the reflective circular polarizer includes at least a light reflecting layer formed by immobilizing a cholesteric liquid crystalline phase.
